(19) United States
(12) Patent Application Publication
(10) Pub. No.: US 2012/0148833 A1
(43) Pub. Date: Jun. 14, 2012

(54) COLORED RADIATION CURABLE COATINGS FOR CONCRETE FLOORS

(76) Inventors: Huimin CAO, Addison, IL (US); Wenguang LI, St. Charles, IL (US); Tia Yeon LEE, Crystal Lake, IL (US)

(21) Appl. No.: 13/390,835

(22) PCT Filed: Jun. 30, 2011
(86) PCT No.: PCT/US2011/042482

§ 371 Date: Feb. 16, 2012

Related U.S. Application Data
(60) Provisional application No. 61/363,118, filed on Jul. 9, 2010.

(30) Foreign Application Priority Data
Jul. 19, 2010 (EP) 10170003.7

(51) Int. Cl. B32B 5/00; C09D 133/04; C09D 133/14; C08J 7/18

(52) U.S. Cl. 428/334; 427/514; 522/182; 522/183; 522/18; 522/64; 522/83; 522/82

(57) ABSTRACT

Radiation-curable coating compositions for a surface such as a concrete floor, which include one or more acrylate monomers or oligomers having at least four crosslinkable double bonds, at least one photoinitiator, one or more fillers, and at least one pigment or dye are described and claimed. These coating compositions allow for application of at least 0.10 mm (4 mil) thickness of the coating composition over an area larger than a radiation source, without the formation of wrinkles along the shoulder area of each pass of the radiation source in the areas where weak intensity light from a side edge of the radiation source is capable of partially curing only a portion of the coating composition thickness. The coating compositions optionally further comprise one or more tertiary amine compounds comprising zero or one crosslinkable double bonds, the one or more tertiary amine compounds providing an amine value of at least 7.5 mg KOH per gram of the total radiation-curable resins of the coating composition. In addition, a method for coating a surface, and a surface coated with the radiation curable coating compositions of the instant claimed invention are described and claimed.

### FIELD OF THE INVENTION

The invention relates to the field of radiation curable coatings. More particularly, this invention is related to the field of radiation-curable floor coatings, for instance concrete floor coatings.

### BACKGROUND OF THE INVENTION

Radiation-curable coatings have been applied to surfaces in various industries for decades. Radiation-curable coatings have also been employed, for example, on surfaces such as concrete floors, vinyl, wood, and the like. As the name implies, radiation-curable coatings are cured by exposure to radiation, such as from UV light, visible light, and electron beams.

A subset of radiation-curable coatings is UV-curable coatings. UV-curable coatings are cured by exposure to at least UV radiation; for instance the UV portion of the electromagnetic spectrum, which includes radiation wavelengths of about 100-400 nanometers (nm). Higher wavelengths of radiation may also be included in addition to the UV radiation.

UV-curable coatings comprise components referred to as “photoinitiators” that absorb UV radiation and are thus raised to an excited state. The photoinitiators then either photolyze or degrade into cations or free radicals, which are extremely reactive species. The cations or free radicals react with the oligomers and/or monomers also present in the UV-curable coatings and polymerize to form cured coatings almost instantaneously, such as within seconds.

One benefit of using UV-curable coatings on floor surfaces is this quick speed at which the coatings are cured. Such rapid curing allows for return to normal use of the floor without lengthy delays as required by alternate coatings, such as coatings containing solvents that must evaporate, or coatings that substantially completely cure over a time span of hours to days. Another benefit provided by many UV-curable coatings is their strong physical and chemical resistance. For example, certain UV-curable coatings applied to floor surfaces can withstand the weight and friction of a forklift driving on the cured, coated surface within minutes after the UV curing. A further benefit of certain radiation-curable coatings is that they comprise 100% solids, and thus do not include volatile organic components in the coating formulations, which allows personnel to work in the area without having significant respiratory health concerns from inhalation of volatile organic components. An additional benefit of UV-curable coatings is that the fact that the polymerization reaction is initiated using UV radiation means that the coating formulation does not have a “pot life”, which refers to the need to use the coating within a certain period of time before it polymerizes in its own container, due to having been mixed with a reactive component. Being a one-component formulation helps eliminate waste from individual projects, as unused coating may be stored for future use.

U.S. Patent Publication No. 2002/0164434 discloses a radiation curable coating that includes an indicator for determining when curable coatings have cross-linked or cured thereby permitting the applies to know what part of the floor may be used without affecting the surface and what part is still in the curing process. The publication discloses incorporation of a dye or pigment into the liquid materials which dye or pigment is visible to the naked eye when the coating is in the liquid state and significantly less visible after the coating has cured.

UV curable concrete coatings are further discussed in the article, “UV Curable Concrete Coatings” by Jo Ann Arceneaux, published in the January/February/March 2009 RADTECH Report (“RADTECH 2009”); in the article, “Field-Applied, UV-Curable Coatings for Concrete Flooring”, by Peter T. Weissman, published in the January/February/March 2009 RADTECH Report; and in the presentation, “Field Applied UV Coatings for Concrete”, by Peter T. Weissman, presented at the UV/EB East October 2009.

A drawback to UV radiation-curable coatings for large surfaces relates to the use of UV radiation sources that are smaller in at least one direction, such as width, than the surface to be cured. For example, typical UV curing instruments are portable machines having a cure width of between about 0.66 meters (26 inches) and 0.86 meters (34 inches). To cure a large floor surface, then, the machine must be passed over the floor, curing an area of just 0.66-0.86 meters (26-34 inches) wide at a time across the length of the floor, followed by curing another area, the width of the machine, directly adjacent to the prior area. The one or more lamps, bulbs, and/or light emitting diodes (LEDs) fixed to the UV curing instrument direct emitted radiation at the floor surface to cure the coating, such as at a power of between about 4000-20000 watts per meter (100 to 500 watts per inch). Despite advances to the design of such portable UV radiation sources, there still exists a stray light zone at the edges of the cure unit where low intensity light leakage from the side light shielding of the machine is sufficient to initiate polymerization of coatings at a certain thickness near the surface and partially cure it to a skin layer, but insufficient to drive the polymerization of coatings to the entire thickness and therefore leaving liquid layer at the bottom of the coating.

Such light leakage adjacent the side edges of the light shield of the UV radiation source typically results in the formation of a wrinkle in the partially cured coating skin layer within seconds of passing the UV curing instrument over the coating. The wrinkle is also referred to as a “buckle”, which exhibits a nonplanar wave pattern that is formed by buckling of the otherwise planar cured portion of the coating located on the top surface of the coating, whereas uncured wet coating remains between the cured portion and the substrate on which the coating was applied. The wrinkle or buckle remains visible at the cured surface, even upon complete curing of the entire thickness by the next curing pass. Each pass down the length of a floor may then be observed as a visible line located at or near the edge of the cured area, which is imparted by the wrinkle or buckle. The wrinkle or buckle comprises a width, thus the wrinkled or buckled area forms part of a shoulder area adjacent to the completely cured main body area. A radiation gradient present at the front of a radiation source is rarely problematic, because as the radiation source proceeds forward, emitted full intensity radiation will quickly drive the polymerization reaction to completion. Similarly, a radiation gradient present at the back of a radiation source is not an issue as the coating at which such weak intensity light is directed has already been fully cured. Typically, wrinkles are not a very serious issue for pigmented (i.e., colored) coatings applied at a thickness of less than about 0.07 mm (3 mils), as even stray light can usually cure through the most thickness of coating to certain cure degree, and any wrinkles that form are very shallow and can be hidden by a clear topcoat, whereas many radiation-curable pigmented coatings applied at a thickness of about 0.07 mm (3 mils) or more are subject to wrinkling that can not be hidden by a clear topcoat.

The formation of wrinkles has historically been a problem for UV coatings in field applied floor applications, in which the surface to be cured is larger than the UV radiation source, and no effective solution to the wrinkle formation problem has been reported. Indeed, the issue of wrinkle formation is reported in the RADTECH 2009 presentation, which discloses on page 15 that wrinkling is “[c]aused by differential cure top to bottom within the film and laterally outside the primary exposure line of sight.” RADTECH 2009 further states on page 16 that wrinkling is “[p]articularly problematic in colors, matte and high build (>8 mils) coatings.” Typically, the current approach to minimize the appearance of wrinkles is to reduce the magnitude of the wrinkle of a primer coat and then to use a topcoat to attempt to cover up any visible wrinkles. The discussions on wrinkle can also be found in Weissman's Radtech 2009 article, which discloses on page 28 that “In this region of partially cured material, the coating is not yet vitrified and, as the shrinkage occurs, the coating can distort. This sometimes shows up as physical markings that resemble a zipper and have in the industry been appropriately coined “zip marks.” These zip marks are difficult to eliminate entirely, but certainly the development of formulations that minimize shrinkage also minimize this phenomenon.”

It would be advantageous to provide a radiation-curable coating formulation that would allow for the application of the coating over an area larger than a radiation source, without the formation of wrinkles along or near the edge of each pass of the radiation source, in the shoulder areas where weak intensity light from a side edge of the radiation source is capable of partially curing only a portion of the coating thickness near the surface. In addition, it would be advantageous to provide a method for coating a surface, for example a concrete floor, with a radiation-curable coating that provides a cured surface free of wrinkles formed by partial curing from stray light from the radiation source.

### SUMMARY OF THE INVENTION

The invention may be embodied in various exemplary and nonlimiting forms. In particular, this Summary is intended merely to illuminate various embodiments of the invention and does not pose a limitation on the scope of the invention.

The first aspect of the instant claimed invention is a radiation-curable coating composition for a concrete floor comprising:

one or more acrylate monomers or oligomers having at least four crosslinkable double bonds;

at least one photoinitiator;

between about 10% and about 50% by weight of at least one filler; and

at least 0.5% by weight of at least one pigment or dye;

wherein when the composition is applied over a predetermined area of a surface of a concrete floor at a thickness of at least 0.10 mm on the surface, and a radiation source is passed over a first portion of the predetermined area of the surface to cure the coating composition, a shoulder area of the predetermined area that includes partially cured coating, that is directly adjacent the first portion and that has not had the UV radiation source pass directly over it, has no wrinkles 0.5 minutes following the completion of the passing of the UV radiation source over the first portion.

The second aspect of the instant claimed invention is a method for coating a concrete floor comprising:

applying a coating composition in a predetermined area over a surface of a concrete floor, the coating composition comprising one or more acrylate monomers or oligomers having at least four crosslinkable double bonds, at least one photoinitiator, between about 10% and about 50% by weight of at least one filler, and at least 0.5% by weight of at least one pigment or dye, the coating composition comprising a thickness of at least 0.10 mm on the surface; and

passing a radiation source over a first portion of the predetermined area of the surface to cure the coating composition,

wherein a shoulder area of the predetermined area that includes partially cured coating, that is directly adjacent the first portion and that has not had the UV radiation source pass directly over it, has no wrinkles 0.5 minutes following the completion of the passing of the UV radiation source over the first portion.

The third aspect of the instant claimed invention is a coated concrete floor comprising:

a floor comprising a surface; and

a coating composition applied directly to the surface, the coating composition comprising one or more acrylate monomers or oligomers having at least four crosslinkable double bonds, at least one photoinitiator, between about 10% and about 50% by weight of at least one filler, and at least 0.5% by weight of at least one pigment or dye, wherein the coating composition has a thickness of at least 0.10 mm.

The fourth aspect of the instant claimed invention is a coated concrete floor coated by the method comprising:

applying a coating composition over a predetermined area of a surface of a concrete floor, the coating composition comprising one or more acrylate monomers or oligomers having at least four crosslinkable double bonds, at least one photoinitiator, between about 10% and about 50% by weight of at least one filler, and at least 0.5% by weight of at least one pigment or dye, wherein the cured coating composition comprises a thickness of at least 0.10 mm;

passing a radiation source over a first portion of the predetermined area of the surface to cure the coating composition,

wherein a shoulder area of the predetermined area that includes partially cured coating, that is directly adjacent the first portion and that has not had the UV radiation source pass directly over it, has no wrinkles 0.5 minutes following the completion of the passing of the UV radiation source over the first portion.

Further to the discussion of the aspects of the instant claimed invention, a radiation-curable coating composition for a concrete floor is provided. The coating comprises one or more acrylate monomers or oligomers having at least four crosslinkable double bonds, at least one photoinitiator, between about 10% and about 50% by weight of at least one filler; and at least 0.5% by weight of at least one pigment or dye. When the composition is applied over a predetermined area of a surface of a concrete floor at a thickness of at least about 0.10 mm on the surface, and a radiation source is passed over a first portion of the predetermined area of the surface to cure the coating composition, a shoulder area of the predetermined area that includes partially cured coating, that is directly adjacent the first portion and that has not had the UV radiation source pass directly over it, has no wrinkles about 0.5 minutes following the completion of the passing of the UV radiation source over the first portion.

Further to the discussion of the aspects of the instant claimed invention, a method for coating a concrete floor is provided. The method comprises applying a coating composition over a predetermined area of a surface of a concrete floor, the coating composition comprising one or more acrylate monomers or oligomers having at least four crosslinkable double bonds, at least one photoinitiator, between about 10% and about 50% by weight of at least one filler, and at least about 0.5% by weight of at least one pigment or dye, the coating composition comprising a thickness of at least about 0.10 mm on the surface, and passing a radiation source over a first portion of the predetermined area of the surface to cure the coating composition, wherein a shoulder area of the predetermined area that includes partially cured coating, that is directly adjacent the first portion and that has not had the UV radiation source pass directly over it, has no wrinkles about 0.5 minutes following the completion of the passing of the UV radiation source over the first portion.

Further to the discussion of the aspects of the instant claimed invention, a coated concrete floor is provided. The coated concrete floor comprises a surface and a coating composition applied directly to the surface, the coating composition comprising one or more acrylate monomers or oligomers having at least four crosslinkable double bonds, at least one photoinitiator, between about 10% and about 50% by weight of at least one filler, and at least about 0.5% by weight of at least one pigment or dye, wherein the coating composition has a thickness of at least about 0.10 mm.

Further to the discussion of the aspects of the instant claimed invention, a coated concrete floor is provided that is coated by the method comprising applying a coating composition over a predetermined area of a surface of a concrete floor, the coating composition comprising one or more acrylate monomers or oligomers having at least four crosslinkable double bonds, at least one photoinitiator, between about 10% and about 50% by weight of at least one filler, and at least about 0.5% by weight of at least one pigment or dye, wherein the cured coating composition comprises a thickness of at least about 0.10 mm (4 mils), and passing a radiation source over a first portion of the predetermined area of the surface to cure the coating composition, wherein a shoulder area of the predetermined area that includes partially cured coating, that is directly adjacent the first portion and that has not had the UV radiation source pass directly over it, has no wrinkles about 0.5 minutes following the completion of the passing of the UV radiation source over the first portion.

Other features and advantages of the invention will become apparent to those skilled in the art upon review of the following detailed description, claims and drawings.

### BRIEF DESCRIPTION OF THE FIGURES

FIG. 1 is a photograph of a prior art coating that has been cured on one side with radiation, illustrating the formation of a wrinkle adjacent to the completely cured area.

FIG. 2 is subdivided into two figures.

FIG. 2a is a photograph of a prior art coating that has been cured using two passes of a UV radiation source, with a delay of about five seconds between the two passes.

FIG. 2b is a photograph of a prior art coating that has been cured using two passes of a UV radiation source, with a delay of about thirty seconds between the two passes.

FIG. 3 is subdivided into two figures.

FIG. 3a is a photograph of a prior art coating applied at a thickness of 4 mils.

FIG. 3b is a photograph of a prior art coating applied at a thickness of 6 mils.

FIG. 4a is a photograph of a cross section of the prior art coating at the wrinkle area of FIG. 3b, under microscope of 20× magnification that shows the angle of the wrinkle.

FIG. 4b is the same photograph as FIG. 4a, marked to show the thickness of the peaks and valleys of a wrinkle in the coating.

FIG. 5 is a photograph of a cross section of an inventive coating at the shoulder area, applied at a thickness of 6 mils, according to an embodiment, under microscope of 20× magnification.

FIG. 6 is a perspective view of a commercially available UV floor curing machine.

FIG. 7 is a graph of peak measured irradiance versus distance from the edge of the light shield of a UV floor curing machine.

FIG. 8 is a partial drawing of a bulb and a shield of a UV radiation source.

FIG. 9a is partial diagram of a large surface coated with a radiation-curable coating, over which one pass of a UV radiation source has been made.

FIG. 9b is a partial diagram of the surface of 9a, over which a second pass of a UV radiation source has been made.

FIG. 10 is a perspective cross-section view of a prior art pigmented coating, another layer of prior art pigmented coating, and a prior art clear topcoat.

FIG. 11 is a photograph of a floor surface comprising a cured pigmented coating composition according to the prior art.

FIG. 12 is a perspective cross-section view of a pigmented coating, another layer of pigmented coating, and a clear topcoat according to an embodiment of the current invention.

FIG. 13 is a photograph of a floor surface comprising a cured pigmented coating composition according to an embodiment of the current invention.

FIG. 14 is a photograph of an inventive coating that has been cured using two passes of a UV radiation source.

### DETAILED DESCRIPTION OF THE INVENTION

### Definitions

The term “wrinkles” is defined to mean a visible wave pattern where the thickness at the valleys of the wave is thinner than the thickness at the flat film area and the thickness at the peaks of the wave is thicker than the thickness at the flat film area. The difference between the thickness at the peak areas and the thickness at the valley areas are at least about 10 μm. The terms “wrinkling”, “buckling” and “zippering” are synonymous and used interchangeably herein, as are the terms “wrinkle”, “buckle” and “zipper”.

The term “flat film area” is defined to mean an area of cured film where the surface of the film is planar.

The term “planar” is defined to mean a surface that generally extends in only one plane and does not include out-of-plane wavelike deformation patterns. A coating that does not comprise wrinkles or buckles is planar, whereas a coating that does comprise wrinkles or buckles is nonplanar.

The term “shoulder area” is defined as comprising a first longitudinal edge located immediately adjacent the area of coating directly over which a UV radiation source has been passed. The shoulder area comprises partially cured coating, which has been subjected to weak intensity UV radiation leaked from the side edge of the UV radiation source. The shoulder area is further defined as comprising a second longitudinal edge located at the boundary of the partially cured coating and the coating that remains uncured.

It is possible that the shoulder area can have coating cured to the bottom, but the coating is only partially cured. The term “partially cured” means that the double bond conversion is low. Therefore, in the shoulder area, it is expected that the coating is partially cured to the bottom, but this partial cure is not to the degree of full cure as in the bulk area. Similarly, the term “partial cure degree” refers to a radiation curable coating that has undergone polymerization; however the double-bond conversion of the polymerization is not complete.

As used herein, the term “about” means±10% of the stated value.

### DESCRIPTION

Aspects of the invention are directed to radiation-curable coatings for surfaces, such as concrete floors, methods for coating radiation-curable coatings onto a surface, and surfaces coated with cured radiation-curable coatings.

As noted above, it would be advantageous to provide a radiation-curable coating formulation that is capable of allowing the application of the coating at a thickness of at least about 0.08 mm (3 mils), or at least about 0.10 mm (4 mils), over an area larger than a radiation source, without the formation of wrinkles in the shoulder area along or near the edge of each pass of the UV radiation source in the areas where weak intensity light radiation from a side edge of the UV radiation source is capable of partially curing only a portion of the coating thickness near the surface. A shoulder area, as noted above, is the area of coating defined as comprising a first longitudinal edge located immediately adjacent the area of coating directly over which a UV radiation source has been passed. The shoulder area comprises partially cured coating, which has been subjected to weak intensity UV radiation leaked from the side edge of the UV radiation source. The shoulder area is further defined as comprising a second longitudinal edge located at the boundary of the partially cured coating and the coating that remains uncured. The width of any shoulder area would depend on various characteristics of the specific coating and UV radiation source, such as coating thickness, coating composition, and UV radiation intensity. In some aspects the shoulder area has a width of from about 0.1 to about 10 cm. In some aspects the shoulder area has a width of from about 0.2 cm to about 5.0 cm. In some aspects the shoulder area comprises a width of at least about 0.5 cm. In an aspect of the invention the shoulder area has a width of approximately 2.0 cm to 3.0 cm. In aspects the width of the shoulder area will be controlled in part by the type of UV radiation source used and the method of such use.

In addition, it would be advantageous to provide a method for coating a surface, for example a concrete floor, with a UV radiation-curable coating that provides a cured surface free of wrinkles formed by partial UV curing from stray light from the radiation source.

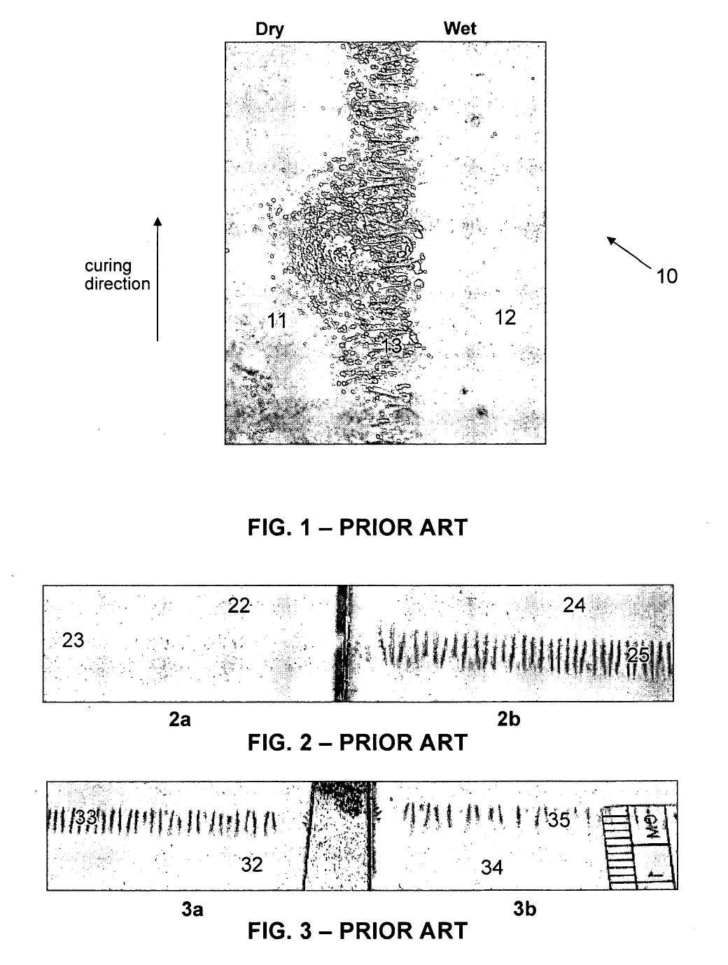

Referring to the drawings, wherein like numbers refer to like elements, FIG. 1 shows a photograph of a 0.13 mm (5 mil) thick gray pigmented prior art coating composition applied to a concrete floor, which illustrates the formation of a wrinkle when only a portion of the coated area 10 is cured. A UV radiation source was passed over a portion of the wet coated area 10 to form a section 11 comprising dry, cured coating, a section 12 comprising wet, uncured coating, and a section 13 comprising partially cured, wrinkled coating. The photograph was taken about one minute following passing of the radiation source over the left portion 11 of the coating.

As previously recited in the definitions section, in addition to the term “wrinkling”, the phenomenon of curing of a coating composition at the surface while uncured coating remains underneath, has also been referred to as “buckling” or “zippering”, due to the appearance of the partially cured area. The terms “wrinkling”, “buckling” and “zippering” are synonymous and used interchangeably herein, as are the terms “wrinkle”, “buckle” and “zipper”. In general, a wrinkled section 13 comprises a pattern of folded, partially cured coating surface segments that are disposed approximately perpendicular to the length of the wrinkled section 13, as shown in FIG. 1. Typically, the individual wrinkles have a fairly well defined wave pattern with certain wavelength, rather than randomly located wrinkles.

A coating that does not comprise wrinkles or buckles is planar, whereas a coating that does comprise wrinkles or buckles is nonplanar. The magnitude, or height, of each wrinkle or buckle typically increases over time until the partially cured coating composition is subjected to the next pass of UV radiation of sufficient intensity to drive the polymerization reaction to completion, at which time the height of the wrinkles or buckles becomes fixed. Referring to FIG. 2, photos are provided of cured prior art gray pigmented coatings. FIG. 2a shows the prior art composition that has been applied to a concrete floor at a thickness of 0.10 mm (4 mils). A UV radiation source was passed over a portion of the wet coated area to form a section comprising dry, cured coating, a section comprising wet, uncured coating, and a section comprising partially cured, wrinkled coating. Next, the UV radiation source was passed over the remaining uncured section of the coating just about five seconds following passing of the UV radiation source over the first portion of the coating composition. A visible wrinkle 23 formed in the coating 22 after a time lapse of only about five seconds between the two passes of the UV radiation source.

In contrast, FIG. 2b shows the prior art composition that has been applied to a concrete floor at a thickness of 0.10 mm (4 mils). The only difference in the cured coating 24 of FIG. 2b and the cured coating 22 of FIG. 2a is that the second pass of the UV radiation source took place about thirty seconds after the first pass of the UV radiation source. The visible wrinkle 25 that formed in the coating 24 after about thirty seconds of delay between the first and second passes of the UV radiation source is significantly larger than the visible wrinkle 23 that formed in the coating 22 after about five seconds of delay between the first and second passes of the UV radiation source. For example, the magnitude and length of each buckle or wrinkle demonstrate a substantial increase between a delay of about five seconds and a delay of about thirty seconds between the first and second passes of the UV radiation source.

Moreover, the magnitude of each wrinkle or buckle is typically proportional to the thickness of the applied coating. For instance, FIG. 3 shows photos of cured prior art gray pigmented coatings having different thicknesses. FIG. 3a shows the prior art composition that has been applied to a concrete floor at a thickness of 0.10 mm (4 mils). A UV radiation source was passed over a portion of the wet coated area to form a section comprising dry, cured coating, a section comprising wet, uncured coating, and a section comprising partially cured, wrinkled coating that was adjacent to the section of dry, cured coating. Next, the UV radiation source was passed over the remaining uncured section and the partially cured section of the coating about thirty seconds following passing of the UV radiation source over the first portion of the coating composition. A visible wrinkle 33 formed in the coating 32 after a time lapse of about thirty seconds between the two passes of the UV radiation source.

In contrast, FIG. 3b shows the prior art composition that has been applied to a concrete floor at a thickness of 0.15 mm (6 mils). The only difference in the cured coating 34 of FIG. 3b and the cured coating 32 of FIG. 3a is that the coating composition of FIG. 3b was applied at a thickness of 0.05 mm (2 mils) greater than the thickness of the coating composition of FIG. 3a. The applied coating of FIG. 3b was cured by the same method as the applied coating of FIG. 3b, having a time lapse of about thirty seconds between the two passes of the UV radiation source. The visible wrinkle 35 that formed in the coating 34, which had been applied at a thickness of 0.15 mm (6 mils), is significantly larger than the visible wrinkle 33 that formed in the coating 32, which had been applied at a thickness of 0.10 mm (4 mils). For example, the magnitude and length of each buckle or wrinkle demonstrate a substantial increase between coatings applied at thickness of 0.15 mm (6 mils) as compared to 0.10 mm (4 mils). Consequently, both the time lapse between UV curing passes and the coating thickness are proportional to the size of the wrinkle or buckle formed in the coating.

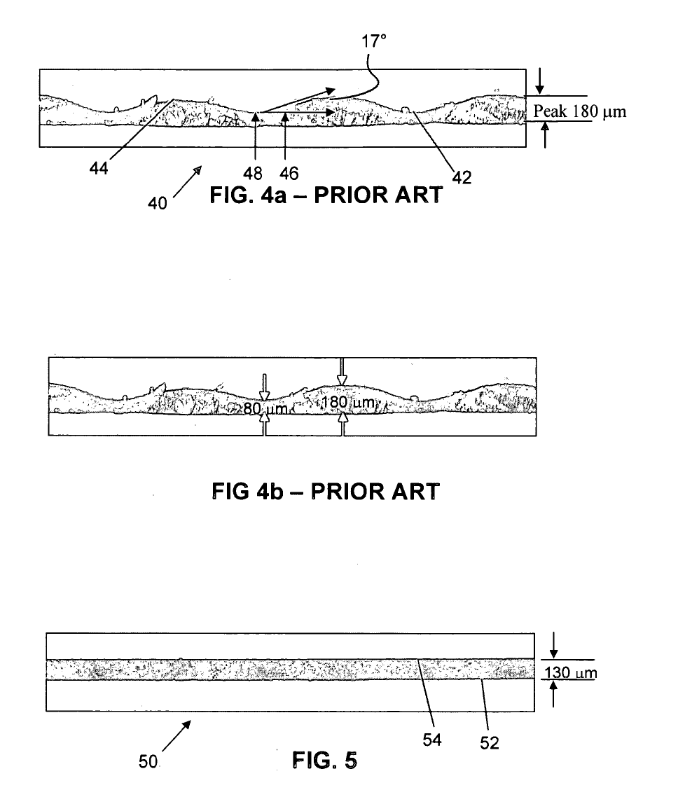

FIG. 4a provides an image of a cross section of the cured coating 34 at the shoulder area of FIG. 3b, under a microscope of 20× magnification. The microscope image of the cured coating cross section 40 illustrates the wavelike shape of the wrinkles. The thickness of the cured coating 34 in a planar, nonbuckled, region of the coating was measured to be about 130 μm (0.13 mm) (about 5.12 mils) thick. The thickness of the valleys 42 of the cross section 40 ranged from about 60 μm (about 2.36 mils) to about 100 μm (about 3.94 mils) thick, which is thinner than the general area of the planar region. In contrast, the thickness of the peaks 44 of the cross section 40 was about 180 μm (about 7.09 mils) thick, which is thicker than the general area of the planar region. The angle 46 of a wrinkle in FIG. 4 is 17 degrees from planar. The angle is measured along the increase in the wrinkle thickness at the peak area beginning at the valley 48.

FIG. 4b is an identical photo to FIG. 4a. FIG. 4b has been marked to show that the thickness of a wrinkle at the peak is 180 μm and the thickness of a wrinkle at the valley is 80 μm.

In contrast to FIG. 4a and FIG. 4b, FIG. 5 provides an image of a cross section of an inventive cured coating at the shoulder area, under a microscope of 20× magnification. The microscope image of the cured coating cross section 50 illustrates that the unlike the peaks and valleys formed in buckled prior art coatings, an even thickness of about 130 μm (0.13 mm) (about 5.12 mils) was achieved throughout the coating composition. The coating was applied at a thickness of 0.15 mm (6 mils) and cured with more than one pass of a UV radiation source, with a time lapse of about one minute between passes. The resulting coating was planar and free of wrinkles.

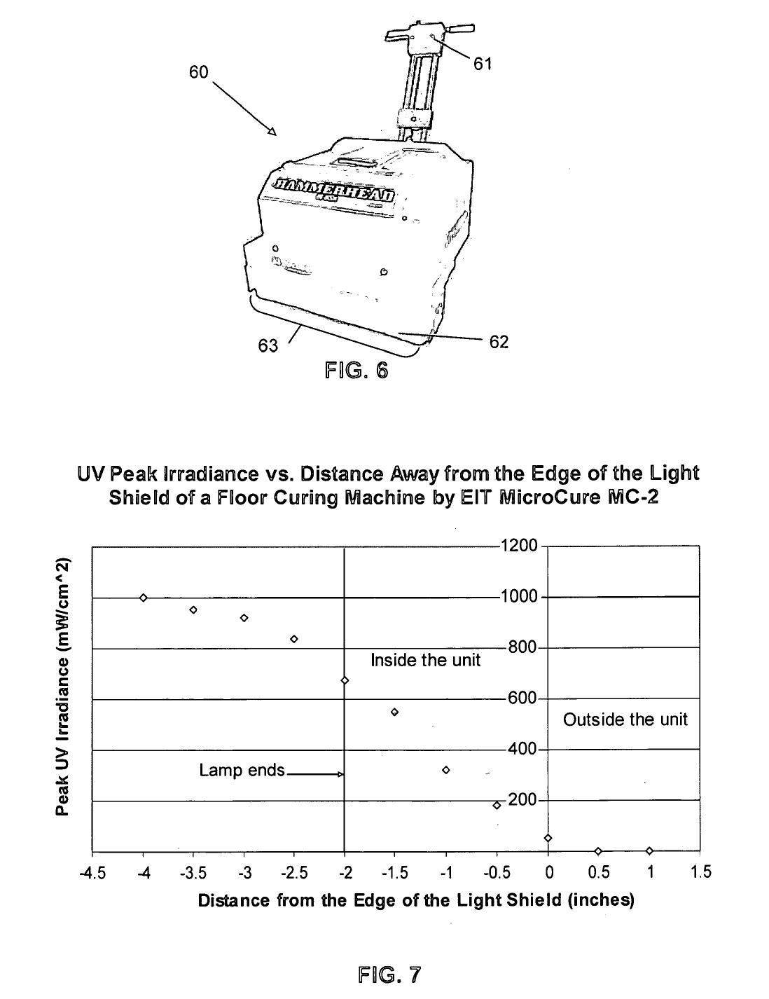

Referring to FIG. 6, one exemplary commercially available radiation source machine 60 is shown. The machine 60 is a Hammerhead UV Floor Curing Equipment model 26-8000A (HID Ultraviolet, Sparta, N.J.). In operation, a UV radiation source 60 directs radiation onto a coated surface to be cured, the radiation provided from mercury vapor lamps and/or bulbs affixed to a lower section 62 of the UV radiation source machine 60. As shown in the figure, the Hammerhead instrument 60 comprises a handle 61 and is thus a machine configured to be walked behind by an operator. The Hammerhead machine 60 shown in FIG. 6 comprises a cure path 63 of 0.66 m (26 inches); consequently, a plurality of passes will be necessary to completely cure the entire coated area for most floor surface applications. The speed at which a radiation source instrument may be passed over a surface is restricted by the amount of light required to drive the polymerization reaction to completion. Accordingly, the speed will depend on the characteristics of specific coating formulations. UV radiation source instrument speeds typically range between about 4.57 m (15 feet) per minute and about 15.24 m (50 feet) per minute, such as between about 6.10 m (20 feet) per minute and 12.19 m (40 feet) per minute, for instance about 7.62 in (25 feet) per minute. UV radiation sources according to embodiments of the invention emit radiation, for example and without limitation, in the range of about 100 nm to about 700 nm, or about 100 nm to about 500 nm, or about 100 nm to about 400 nm.

An alternate radiation source is a machine comprising light emitting diodes (LEDs). LED radiation sources are disclosed in PCT Patent Application, PCT/US2010/60647, “D1446 BT LED Curing of Radiation Curable Floor Coatings” which claims priority to U.S. Provisional Patent Application No. 61/287,600 filed on Dec. 17, 2009. PCT Patent Application, PCT/US2010/60647 and U.S. Provisional Patent Application No. 61/287,600 are incorporated herein by reference in their entirety.

Radiation intensity can be measured at various locations with respect to a selected radiation source. For example, referring to FIG. 7, a graph is provided showing the UV-A (320-390 nm) peak irradiance for a mercury vapor bulb radiation source, as a function of the distance from the edge of the light shield. The irradiance was measured using a MicroCure MC-2 chip (EIT, Inc, Sterling, Va.). Each measurement was taken where the chip was placed on the floor, first directly in the path of the radiation emitted from the bulb. Next, the chip was placed half of an inch closer to one longitudinal side end of the bulb and the irradiance measured. For each subsequent measurement, the chip was placed an additional half of an inch closer to and then beyond the longitudinal side end of the bulb, past the light shield of the machine, and outside of the unit.

FIG. 7 illustrates the decrease in peak UV-A irradiance with respect to distance from the edge of the light shield. A typical UV-A radiation high intensity provided by such a bulb from the longitudinal center of the bulb is about 1700 mW/cm². Between the end of the bulb and the edge of the light shield, the peak irradiance dropped from 673 mW/cm² to 53 mW/cm². Interestingly, even an irradiance as low as just 53 mW/cm² can be sufficient to cure the entire thickness of colored radiation-curable coatings having a thickness of about 0.07 mm (3 mils). It was only at half an inch or more outside of the equipment shield, where the irradiance was below the minimum detectable level of about 5-10 mW/cm², that partial curing of only the skin layer from the stray light occurred. As one of skill in the art will appreciate, the distance longitudinally from the end of a radiation source at which the radiation is sufficiently weak to result in only partial curing the skin layer will depend on characteristics of the particular radiation source, such as the bulb, lamp or LED intensity, equipment shield configuration and location, distance of the radiation source from the coated surface, etc.

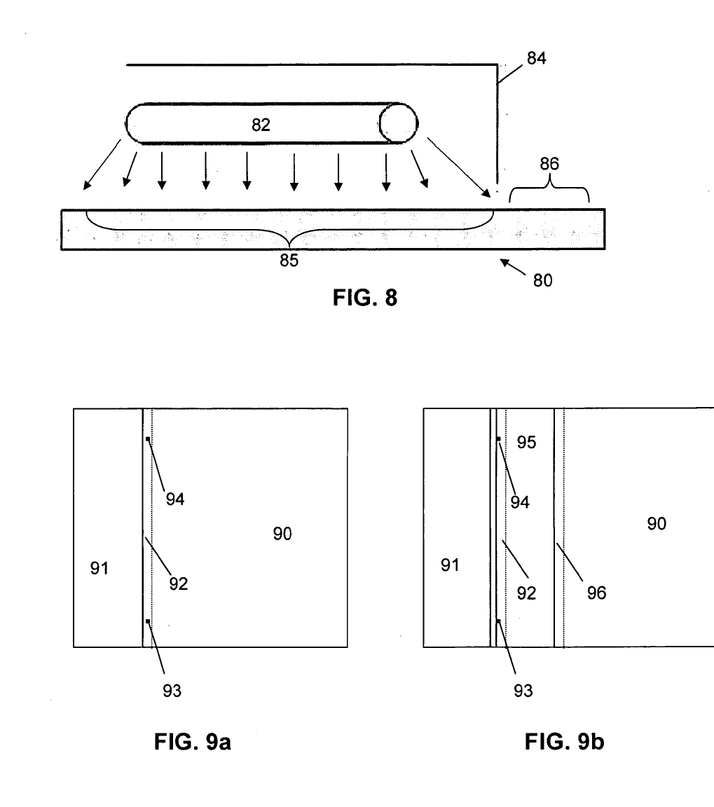

FIG. 8 provides a basic representation of the configuration of a UV radiation source lamp 82 and light shield 84 with respect to each other and a coated surface 80 to be cured. The arrows provide a depiction of the direction of the radiation provided by the lamp 82 as it is moved over the coated surface 80 during a curing pass. The main body area 85 of the coated surface 80, which is located directly below the lamp 82, receives direct high intensity light radiation, whereas the shoulder areas of the coated surface 80, which are off to the sides of the lamp 82, and not directly under the lamp 82, receive indirect light radiation. As indicated by the measurements shown in FIG. 7, a shoulder area 86, which is located on the coated surface 80 beyond the light shield 84, receives weak intensity radiation that leaks underneath and past the light shield 84. Typically, within this shoulder area 86 is where a buckle or wrinkle forms upon being subjected only to enough radiation to partially cure the skin layer of the coating.

In use, a UV radiation source employed to cure a large surface coated with a radiation-curable composition will usually be passed over the surface as depicted in the representations shown in FIGS. 9a and 9b. Referring to FIG. 9a, a rectangular surface 90 is shown having a radiation-curable coating applied to the surface 90. The selected UV radiation source (not shown) is passed over the coated surface 90 starting at the lower left corner of the area shown in FIG. 9a and moving towards the upper left corner to cure the coated main body area 91 in the first pass. The weak intensity radiation that is provided adjacent to the high intensity radiation partially cures the skin layer of the coated shoulder area 92 despite the UV radiation source not passing over the shoulder area 92. The UV radiation source is passed over the coated surface at a suitable predetermined speed, such as between about 1.52 m (5 feet) and about 18.29 m (60 feet) per minute. Consequently, if more than one pass of a UV radiation source must be made over the coated area 90 in order to cure the entire width of the area, there will be a time lapse between the start of the first pass and the start of the second pass.

For instance, in an embodiment, if the coated area 90 has a width of 3.05 m (10 feet) and a length of 3.05 m (10 feet), and a UV radiation source has a cure width of 0.86 m (34 inches) and a cure speed of about 3.05 in (10 feet) per minute, a first spot 93 located at approximately 0.90 m (35 inches) width and 0.15 in (6 inches) length (within the shoulder area 92) on the coated area 90 will become partially cured by the weak intensity stray radiation from the UV radiation source about 3 seconds into the first pass of the UV radiation source over the coated area 90. A second spot 94 located at approximately 0.90 m (35 inches) width and 2.90 in (9 feet 6 inches) length on the coated area 90 (also within the shoulder area 92) will become partially cured by weak intensity stray radiation from the UV radiation source at a time of about 57 seconds. Referring now to FIG. 9b, if the UV radiation source is then turned immediately around and passed over the second main body area 95 directly adjacent to the first cured main body area 91 and overlapping the partially cured shoulder area 92, the UV radiation source will pass over the second spot 94 and will subject it to high intensity radiation about 3 seconds after the second curing pass has begun. Accordingly, the time lapse between partially curing and completely curing the second spot 94 is at least about 6 seconds. In contrast, the UV radiation source will pass over the first spot 93 and will subject it to high intensity radiation from the UV radiation source at least about 57 seconds after beginning the second curing pass. The time lapse between partially curing and completely curing points along the shoulder area 92 may range from several seconds to over one minute. As shown in FIG. 9b, the second pass will create a second main body completely cured area 95 and a second shoulder area 96 despite the UV radiation source not passing over the shoulder area 96.

Consequently, the size of a coated surface and the speed at which a UV radiation source is passed over the coated surface will impact the time lapse between a shoulder area being partially cured by weak intensity radiation from a first curing pass and being completely cured by high intensity radiation from a second curing pass. For large surface areas, it is impractical to complete two directly adjacent curing passes of the entire coating composition on the surface in less than about 30 seconds (0.5 minutes), for example. As a result, it is an advantage of coating compositions according to the present invention to prevent wrinkling or buckling of the partially cured coating located in the shoulder area adjacent to a main body area that has been fully cured by a first pass of a UV radiation source, for at least about 30 seconds or until a second pass of the UV radiation source can be made to completely cure the shoulder area. In certain embodiments, the inventive coating compositions are free of wrinkles following subjection to weak intensity radiation for at least about 0.5 minutes, or at least about one minute, or at least about two minutes, or at least about five minutes, or at least about ten minutes, or at least about twenty minutes, or at least about thirty minutes, prior to being completely cured by subjection to high intensity radiation from a UV radiation source.

Experiments can be executed to determine the amount of time for wrinkles to form in a shoulder area. Referring again to FIG. 9a, a UV-curable coating composition can be applied to a small surface area 90 such as on a 4 inch×6 inch metal panel. Due to the small coating area, the test panel is placed on one side of the curing path so that when the curing machine passes over part of the test panel, the first main body area 91 on the test panel is directly under the curing machine. The amount of time can then be observed as to when wrinkles begin to form in the shoulder area 92, despite the curing machine not passing over the shoulder area 92. While experiments can be performed with coating on metal panels, the coating, in aspects of the invention, is applied to concrete floors or other substrates.

Despite various design modifications, it is not believed that there are any available radiation sources that provide a radiation cutoff from high intensity light to zero light (e.g., does not provide a leakage of weak radiation at the edges of the shielding of one or more lamps, bulbs, and/or LEDs of the radiation source). Aspects of the present invention, however, overcome the problem of wrinkle formation caused by low intensity light leakage by providing specific compositions of pigmented radiation-curable coating formulations. Accordingly, the particular type or instrument model of the radiation source is not a significant factor in achieving wrinkle-free UV-cured coatings according to embodiments of the invention, and any conventional radiation source may be employed with aspects of the current invention.

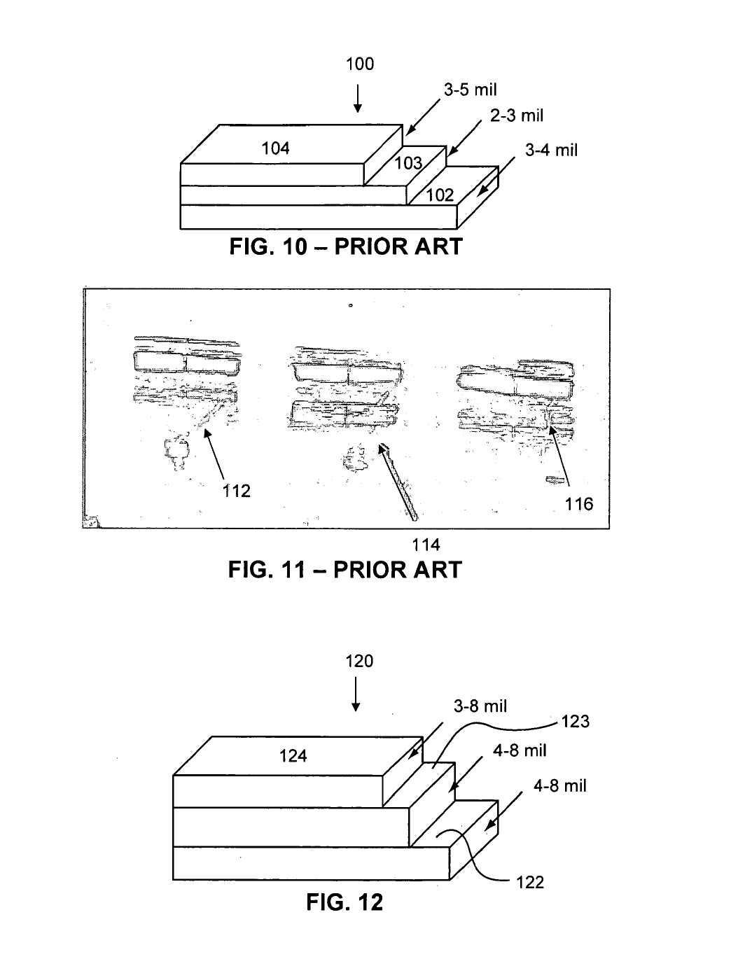

Referring to FIG. 10, a cross-section of a colored coating system 100 according to the prior art is illustrated. Pigmented coatings can be applied in multiple layers to achieve the desired hiding level. The first layer of pigmented coating 102 is applied directly to a surface (not shown), an additional pigmented coating layer 103, and a clear topcoat coating 104 applied on top of the pigmented coating layer 103. Optionally, a clear primer may be applied directly on the floor underneath the pigmented coating. Typically, coatings applied directly on a substrate are configured to provide adhesion of the radiation-curable coatings to the surface, such as to a concrete surface. One or more additional layers of pigmented coating 103 are optionally included between the first layer pigmented coating 102 and topcoat coating 104, usually when the pigmented coating 102 does not provide sufficient hiding of the appearance of the surface underneath. Topcoats are usually formulated to provide properties such as mechanical and chemical resistance and a desired level of gloss. Due to the problem of wrinkle formation, many prior art pigmented coating compositions could only be applied to large areas at a maximum thickness of 0.05 mm to 0.08 mm (2 to 3 mils) or (3 to 4 mils) 0.08 mm to 0.10 mm. Even at these thickness levels, the prior art pigmented coatings normally will show wrinkle lines along the curing passes. The typical approach is to reduce the magnitude of the wrinkles of the pigmented coating layer and apply 0.08 mm-0.13 mm (3-5 mils) of the clear topcoat, to attempt to cover up any visible wrinkles in the final finish. This approach has the limitation that when the wrinkle magnitude is large enough, even when the topcoat can physically cover the wrinkles from the pigmented coating layer, optically the wrinkles can still show through the topcoat and appear as visible wrinkles lines in the final finish.

FIG. 11 provides a photograph of a prior art 2-layer pigmented coating with both layers at about 0.10 mm (4 mils) thickness on concrete, further comprising a clear topcoat coating. The photograph shows wrinkle lines 112, 114 and 116 visible in the cured pigmented coating.

As noted above, the present invention provides a solution to the problem of wrinkle formation in pigmented radiation-curable coating compositions such that coatings of 0.10 mm (4 mils) or higher may be applied to large areas and cured via radiation without the generation of visible wrinkles. The wrinkle formation is commonly believed to be related to the cure shrinkage of the partially cured coating as discussed in Weissman's UV/EB East 2009 presentation and Radtech 2009 article. In the Radtech 2009 article, it was firmly suggested that “These zip marks are difficult to eliminate entirely, but certainly the development of formulations that minimize shrinkage also minimize this phenomenon.”

It was unexpectedly discovered that the addition of one or more acrylate monomers or oligomers having at least four crosslinkable double bonds to certain pigmented coating compositions prevents the formation of wrinkles during curing, or can delay the wrinkle formation long enough to allow the time lapse, which is normally about a half minute or more, before being cured by the next curing pass. This is surprising at least because typically, the greater the number of crosslinkable double bonds present, the more prone to cure shrinkage a polymerized coating will be. The final finish of the color coat composition with one or more acrylate monomers or oligomers having at least four crosslinkable double bonds rather appears planar and continuous across a plurality of portions that were cured in separate passes of the radiation source. This finding is in direct contrast to the previous teachings in the art. In Arceneaux's Radtech 2009 article page 37, the author also pointed out “Tri- and higher-functionality monomers are typically higher in viscosity and are not as effective in reducing the viscosity of the oligomers. They increase the cure speed of a coating, but can also impart brittleness to the coating. Increased crosslink density typically improves hardness, abrasion and scratch resistance, and chemical and solvent resistance.” However, all these surface properties are designed for top coats. In this invention, the use of these high functionality monomers/oligomers in the color coat surprisingly results in significant improvement with respect to removing wrinkles.

Monomers and oligomers comprising at least four crosslinkable double bonds have been employed in radiation-curable compositions as part of the polymerizable compositions, such as to increase hardness and chemical resistance of the cure coating composition. However, it is not believed that there has been any investigation into the effects of high functionality monomers and oligomers on the polymerization of compositions at extremely low radiation intensities. Without wishing to be bound by theory, it is hypothesized that the inclusion of at least about 10% by weight acrylate monomers or oligomers comprising at least four crosslinkable double bonds which impart high reactivity assists the composition in curing enough of the coating thickness from the surface down to prevent wrinkling of the partially cured skin layer of the coating for at least about a half minute or longer. In certain aspects, wrinkling is prevented regardless of the length of the waiting time.

In certain embodiments of the invention, monomers or oligomers are present in the pigmented radiation-curable composition. Suitable monomers having at least four crosslinkable double bonds for the pigmented radiation-curable composition include, for example and without limitation, dipentaerythritol pentaacrylate (e.g., Sartomer SR 399), di-trimethylolpropane tetraacrylate (e.g., Sartomer SR 355) and combinations thereof. Suitable oligomers for the pigmented radiation-curable composition include, for example and without limitation urethane acrylate oligomers, epoxy acrylate oligomers and polyesteracrylate oligomers. Aliphatic urethane acrylate oligomers such as Neorad U-10 are available from DSM and aromatic monoacrylate oligomers, such as CN131B, are available from Sartomer.

In certain aspects, oligomers are included in the radiation-curable composition formulation in an amount of between about 5% and about 40% by weight or between about 10% and about 30% by weight, or at least about 5% by weight, or at least about 10% by weight, or about 20% by weight of the total composition.

It also was unexpectedly discovered that the use of fillers in the coating composition can assist in the prevention, decrease or delay of the formation of wrinkles. Radiation-curable compositions according to certain embodiments of the invention comprise at least one filler component to enhance the ability of the composition to cure without the formation of visible wrinkles, such as in an amount of 5-25 weight %, or 10-20 weight % of the total composition, or 10-50 weight % of the total composition, and in some embodiments an amount of at least 5 weight %, at least 10 weight % or at least 20 weight % of the total composition. Suitable fillers include materials that have no significant absorption to visible light radiation (i.e., wavelengths longer than about 400 nm) and at least a portion of UV light radiation (i.e., wavelengths between about 250 nm and about 400 nm). Such suitable fillers according to aspects of the invention are for example and without limitation, fillers selected from the group consisting of silica oxide particles, silicate particles, ceramic spheres, clay particles, calcium carbonate particles, aluminum oxide particles, aluminum hydroxide particles, aluminum trihydrate, calcium sulfate particles, barium sulfate particles, solid glass beads, hollow glass beads, glass fibers, glass flakes, acrylic particles, polyolefin particles, silicon particles, and combinations thereof. For example, ceramic microspheres are commercially available from 3M (St. Paul, Minn.), Sphericel® hollow glass spheres are commercially available from Potters Industries Inc. (Valley Forge, Pa.), and glass fibers are commercially available from Owens Corning. In certain aspects, the average particle size of the fillers comprises 300 microns or less in at least one dimension.

In certain aspects, the average particle size of the fillers comprises 300 microns or less in at least one dimension. Without wishing to be bound by theory, it is hypothesized that the UV transparent filler particles conduct light to assist in driving the polymerization reaction to the greater depth. One or more fillers are present in radiation-curable compositions in an amount of between about 1% and about 70% by weight, or between about 5% and about 60%, or between about 10% and about 50%, or between about 15% and about 40%, or between about 20% and about 30%, or between about 10% and about 20% by weight of the total radiation-curable composition. In certain embodiments of the present invention, both tertiary amine compounds and fillers are included in pigmented radiation-curable compositions to provide synergistically enhanced curing of the compositions without the formation of visible wrinkles.

As shown in examples 10-12 below, the type of filler used can have an impact on the amount of time it takes for wrinkles to form in a shoulder area of a coating after a radiation source has passed over a portion of the coating adjacent the shoulder area. With identical coating formulations other than the type of filler, wrinkles in the shoulder area of the coating comprising barium sulfate as the filler form 6 minutes after the radiation source passed over a portion adjacent the shoulder area; wrinkles in the shoulder area of the coating comprising glass fiber as the filler form after 5 minutes; in the shoulder area of the coating comprising aluminum trihydrate as the filler wrinkles form after 3 minutes. In comparison, when using the hollow glass spheres 110P8 as filler in example 2 with the rest of the composition the same as examples 10-12, wrinkles do not form for at least 10 minutes and may not form at all regardless of the waiting time.

It was also unexpectedly discovered that the addition of tertiary amine further assists in preventing, limiting or delaying the formation of wrinkles. In certain embodiments, tertiary amine compounds are included in the radiation-curable composition to enhance the ability of the composition to cure without the formation of visible wrinkles, such as providing an amine value in an amount of at least 7.5 milligrams KOH per gram of the total radiation-curable resins in the coating composition. Tertiary amine compounds have been employed as peroxide scavengers for overcoming oxygen inhibition of polymerization at the coating surface of UV-curable coatings, plus as synergists for Norrish Type II photoinitiators (i.e., photoinitiators that form an active species by a hydrogen abstraction process). Tertiary amines are normally used in the surface coating layer where surface cure is very important. In this invention, tertiary amine compounds are unexpectedly used in the color coating. Without wishing to be bound by theory, it is hypothesized that the effect of tertiary amine on preventing wrinkle formation is related to its effect in the area with very low radiation intensities. It is not believed that there has been any investigation into the effects of tertiary amines on polymerization at extremely low radiation intensities such as the stray light condition disclosed in this application. In fact, the amount of radiation provided by light leakage from UV radiation sources is not even above the minimum detectable level of a typical dosimeter, which is about 5-10 mW/cm². Without wishing to be bound by theory, it is hypothesized that at such low levels of radiation intensity, the small amounts of dissolved oxygen throughout the coating inhibit the photoinitiated polymerization reaction, thus the inclusion of a chain transfer agent, in particular one or more tertiary amine compounds, assists to partially cure enough thickness of the coating from the surface down to prevent wrinkling of this thick skin layer for up to about twenty minutes. In certain aspects, wrinkling is prevented completely regardless of the waiting time.

The preferred tertiary amine compounds include tertiary amine compounds comprising zero or one crosslinkable double bonds, for instance acrylate double bonds, which may also be referred to as “acrylate functionality”. Suitable tertiary amine compounds also include the salts of such compounds. Acrylated amines are commonly preferred over the non acrylated amines due to their advantages of low odor, low extractables, and improved yellowing as compared to the non acrylated amines. When non acrylated amines are employed, it is typically in a low amount, such as less than an amount sufficient to provide an amine value of less than 7.5 milligrams KOH per gram of the total amount of radiation-curable resins of the radiation-curable composition. Surprisingly, tertiary amine compounds having high acrylate functionality, i.e., comprising two or more crosslinkable double bonds, were not effective at preventing wrinkle formation for about one to about twenty minutes between passes of the UV radiation source. This is unexpected at least because the level of acrylate functionality is not supposed to affect a particular tertiary amine compound's effect on oxygen inhibition during polymerization.

Suitable tertiary amine compounds include some commercially available compounds and mixtures, for example and without limitation CN 386, CN 383 and CN 384, which are each available from Sartomer Company, Inc. (Exton, Pa.), and Ebecryl® P115, available from Cytec Industries Inc. (Woodland Park, N.J.). CN 386, CN 384 and CN 383 are tertiary amines, marketed by Sartomer Company, Inc. as difunctional amine coinitiators for use in conjunction with a photosensitizer such as benzophenone to promote rapid curing under radiation. CN 383 is a tertiary amine compound with zero crosslinkable double bonds. CN 384 is a tertiary amine compound with one crosslinkable double bond. CN 386 is a tertiary amine compound with zero crosslinkable double bonds. Ebecryl® P115 is a copolymerizable amine marketed by Cytec Industries Inc. as a hydrogen donor, or photoactivator, in radiation-curable coatings, optionally in combination with a photosensitizer. Additional suitable tertiary amine compounds for certain embodiments of the invention include for example and without limitation tertiary amine compounds selected from the group consisting of triethylamine, triethanolamine, N,N-dimethyl-p-toluidine, methyldiethanolamine, dimethylethanol-amine, 2-n-butoxyethyl-4-dimethylaminobenzoate, 2-ethyl-p-(N,N-dimethylamino) benzoate, 2-ethylhexyl-p-dimethylaminobenzoate.

In embodiments of the invention, one or more tertiary amine compounds having zero or one crosslinkable double bonds are used in an amount sufficient to provide an amine value of at least 7.5 milligrams KOH per gram of the total amount of radiation-curable resins of the radiation-curable composition. The amine value of a particular tertiary amine sample is expressed as the number of milligrams of potassium hydroxide equivalent to the amine basicity in 1 g of the sample. In certain aspects, the one or more tertiary amine compounds are included in an amount sufficient to provide an amine value of at least 9 milligrams, or at least 12 milligrams, or at least 15 milligrams, or at least 20 milligrams, or at least 40 milligrams KOH per gram of the total amount of resins of the radiation-curable composition, and excludes components such as inorganic fillers. The amount of the one or more tertiary amine compounds will also depend on the rest of the components present in the radiation-curable composition.

In embodiments of the invention, the one or more tertiary amine compounds equal at least 5 weight % of the total amount of the radiation-curable composition. In certain aspects, the one or more tertiary amine compounds are included in an amounts equal to at least 10 weight %, at least 13 weight %, at least 15 weight %, or at least 20 weight %, of the total amount of the radiation-curable composition. The tertiary amine compounds, as discussed previously, include the salts thereof.

Radiation-curable compositions according to the invention comprise at least one photoinitiator to initiate the polymerization reaction upon absorption of radiation. Photoinitiators and stabilizers are described in the reference text MODERN COATING TECHNOLOGY cited above, on pages 29-34. In general, free radical photoinitiators are well known in the art of radiation curable coatings. See pages 105 of the article entitled “Optical Fiber Coatings” by Steven R. Schmid and Anthony F. Toussaint, DSM Desoteeh, Elgin, Ill., Chapter 4 of Specialty Optical Fibers Handbook, edited by Alexis Mendez and T. F. Morse, ©2007 by Elsevier Inc., for a succinct summary of these types of photoinitiators.

Typically, free radical photoinitiators are divided into those that form radicals by cleavage, known as “Norrish Type I” and those that form radicals by hydrogen abstraction, known as “Norrish Type II”. As discussed above, tertiary amine compounds have been known to be used as synergists in conjunction with Norrish Type II photoinitiators. Although certain embodiments of the invention comprise Norrish Type IT photoinitiators in the UV radiation-curable composition formulation, synergy between a Norrish Type II photoinitiator and a tertiary amine compound is not necessary for the instant invention. Indeed, embodiments of radiation-curable coating compositions of the current invention comprise Norrish Type I photoinitiators, which generate free radicals via a fragmentation process (e.g., via cleavage). Any suitable Norrish Type I photoinitiator may be employed, for example and without limitation, a photoinitiator selected from the group consisting of acyl phosphine oxides, benzoin ethers, 2,2-diethoxyacetophenone, benzyl dimethylketal, 1-hydroxycyclohexylphenyl-ketone, 1-hydroxycyclohexyl benzophenone, 2-hydroxy-2-methyl propiophenone, 2-ethoxy-2-isobutoxyacetophenone, 2,2-dimethyl-2-hydroxyacetophenone, 2,2-dimethoxy-2-phenylacetophenone, 2,2,2-trichloro-4-t-butylacetophenone, 2,2-dimethyl-2-hydroxy-4-t-butylacetophenone, 1-phenyl-1,2-propanedione-2-O-ethoxycarbonyl ester, 1-phenyl-1,2-propanedione-2-O-benzoyl oxime, and combinations thereof. For embodiments comprising Norrish Type II photoinitiators, any suitable Type II photoinitiator as typically known in the art may be employed in the inventive UV-curable compositions. Photoinitiators are included in embodiments of the radiation-curable compositions at any suitable amount, for example and without limitation, between about 0.1% and about 5% by weight, between about 1% and about 4% by weight, or about 3% by weight of the total composition.

UV radiation-curable compositions according to certain embodiments of the invention comprise at least one pigment or dye to provide color, hiding of the coated floor surface, or combinations thereof. Suitable pigments comprise any pigments commonly known in the art, for example and without limitation carbon black, rutile titanium dioxide, copper phthalocyanine green or blue, and lithol red. Suitable dyes include for example and without limitation, dyes typically employed in the art of colored coating compositions. The at least one pigment or dye is included in embodiments of the radiation-curable compositions in any suitable amount, for example and without limitation between about 0.5% and 10% by weight, or between about 0.5% and about 5% by weight, or between about 0.5% and about 3% by weight, or at least about 0.5% by weight of the total radiation-curable composition.

Pigments and dyes are known to absorb UV and visible light and therefore decrease the rate or extent of polymerization of radiation-curable compositions. Consequently, pigmented or dyed radiation-curable coatings are typically applied in thinner coats than clear coatings in order to successfully provide a cured coating composition that is free of wrinkles. As different pigments and/or dyes may be included in coatings at a wide variety of percentages by weight and imparting a wide range of optical densities (e.g., hiding) to the radiation-curable coatings, one method to define the amount of pigment or dye included in pigmented compositions according to aspects of the invention is an amount of pigment or dye that, in a coating identical to the current inventive pigmented coating except without the one or more acrylate monomers or oligomers comprising at least four crosslinkable double bonds, would have resulted in a cured coating comprising visible wrinkles. For instance, the pigment or dye is present in an amount such that when a coating composition comprising a certain thickness, such as a thickness of at least 0.10 mm (4 mils) on a surface, and comprises at least one photoinitiator, at least one pigment, and at least 10% by weight of monomers and/or oligomers, where the coating composition comprises one or more acrylate monomers or oligomers having fewer than four crosslinkable double bonds in place of the one or more acrylate monomers or oligomers having at least four crosslinkable double bonds, and when the coating is cured using more than one pass of a radiation source, the cured coating comprises a visible wrinkle. Accordingly, the amount of pigment or dye is such that when it is included in pigmented prior art coating compositions, a visible wrinkle is formed upon radiation curing of more than one portion of a coating. In contrast, compositions according to the invention and comprising the same amount of pigment or dye are free of wrinkles upon curing of more than one portion of a coating by radiation.

In certain embodiments of the invention, a 0.5% titanium dioxide test demonstrates whether or not a particular base UV-curable coating composition (e.g., a composition prior to the addition of one or more pigments and/or dyes) will be expected to form wrinkles when the coating is applied to a surface at a thickness of at least 0.10 mm (4 mils) and cured using more than one pass of a UV radiation source. This 0.5% titanium dioxide test is one effective method for standardizing the wrinkle formation of a UV-curable coating composition regardless of the specific amount and/or type of pigment(s) to be included in the UV-curable coating composition. In particular, the 0.5% titanium dioxide test comprises adding 0.5% by weight titanium dioxide as the only pigment to a base UV-curable coating composition, applying the resulting pigmented UV-curable coating composition to a clean surface to form a coating comprising a thickness of 0.10 mm (4 mils), and passing a UV radiation source over at least two directly adjacent portions of the coated surface. If a wrinkle forms at the edge between the two adjacent portions within about half of a minute of the first pass, the UV-curable coating composition fails the 0.5% titanium dioxide test. In contrast, if no wrinkle forms at the edge between the two adjacent portions within about half of a minute of the first pass, the UV-curable coating composition passes the 0.5% titanium dioxide test. To obtain the most consistent results from use of this test, the same UV radiation source and settings are preferably employed for every test of base UV-curable coating compositions, such as a HID Hammerhead UV Floor Curing Equipment model 26-8000A (as shown in FIG. 2). The HID Hammerhead machine comprises a mercury vapor lamp, provides 8000 watts, is powered at 208/240 volts, 60 hertz, 45 amps, and is set to one of a range of automatic propulsion cure speeds, such as about 7.62 m (25 feet) per minute.

Radiation-curable compositions according to certain embodiments of the invention comprise at least one monomer in the 100% solids compositions. In certain aspects, the at least one monomer is a reactive diluent monomer. Reactive diluent monomers are well known in the art of radiation curable coatings for optical fiber and many of the reactive diluent monomers that are present in radiation curable coatings for optical fiber are also used in radiation curable coatings for concrete and wood floors. See pages 105 of the article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of reactive diluent monomers.

In embodiments of the invention, suitable monomers for the radiation-curable compositions include for example and without limitation, monomers typically employed in the art of radiation-curable compositions and known by persons skilled in the art. In embodiments of the invention, the one or more monomers are included in an amount of between about 5% and about 90% by weight, or about 10% and about 80%, or about 20% and about 70%, or about 30% and about 60%, or about 40% and about 50% by weight of the total radiation-curable composition.

In certain embodiments, the pigmented radiation-curable coating system further comprises a topcoat composition, such as a clear topcoat coating for concrete. Such topcoat coatings are applied on top of pigmented coatings. Referring to FIG. 12, a cross-section of a pigmented coating 120 according to an embodiment of the invention is illustrated. Pigmented coatings 120 may be made up of more than one individual coating layer, such as the first layer 122 applied directly to a surface (not shown), an additional layer of the pigmented coating 123 applied on top of the first layer 122, and a clear topcoat coating 124 applied on top of the pigmented coating 123. Typically, the coatings applied directly on concrete are configured to provide adhesion of the radiation-curable coatings to the surface, such as to a concrete surface. Topcoats are usually formulated to provide properties such as physical and chemical resistance and a desired level of gloss. Due to the advantages of inventive formulations of radiation-curable coating compositions, pigmented coating compositions according to certain aspects of the invention can be applied to large areas at a thickness of at least 0.10 mm (4 mils) for the pigmented coat, or at least 0.13 mm (5 mils), or at least 0.15 mm (6 mils) thick.

One advantage of coating compositions according to the present invention is that thicker coatings that are free of wrinkles can be applied than previously feasible. As a result, fewer layers of coating may be necessary to provide sufficient hiding of the surface underneath the one or more pigmented radiation-curable coatings. Moreover, another advantage of pigmented radiation-curable coating compositions according to the present invention is that greater hiding is provided by thinner coatings than provided by the prior art. For example, a 3 mil thick pigmented prior art coating may provide 80.7% hiding, and a 6 mil thick pigmented prior art coating may provide 97.2% hiding, whereas a 3 mil thick pigmented coating of the present invention comprising a filler provides 88% hiding, and a 6 mil thick pigmented coating provides 99.5% hiding of the surface underneath.

In certain embodiments, the radiation-curable composition comprises a primer coating composition, such as a pigmented primer coating composition for concrete. Such primer coating compositions are applied directly to clean surfaces to provide good adhesion of the coating to the particular surface, such as concrete. The surface may be cleaned according to methods commonly used in the art of surface coating, wherein the cleaning comprises removing debris and optionally coatings adhered to the surface. In alternate embodiments, the primer coating composition is applied directly to substrates such as wood, vinyl, composite materials, and the like.

Aspects of the inventive radiation-curable compositions allow for a higher build pigmented coating composition than previously possible, such as a pigmented coating composition to be applied to a surface that has a thickness of at least 0.10 mm (4 mils), or at least 0.13 mm (5 mils), or at least 0.15 mm (6 mils), or at least 0.18 mm (7 mils), or at least 0.20 mm (8 mils), or at least 0.23 mm (9 mils), or at least 0.25 mm (10 mils). Such high build pigmented coatings on surfaces having an area with at least one dimension greater than the width of a radiation source are capable of being cured using radiation in more than one pass of the radiation source having a time lapse of between about half and about twenty minutes between passes, while remaining free of wrinkles.

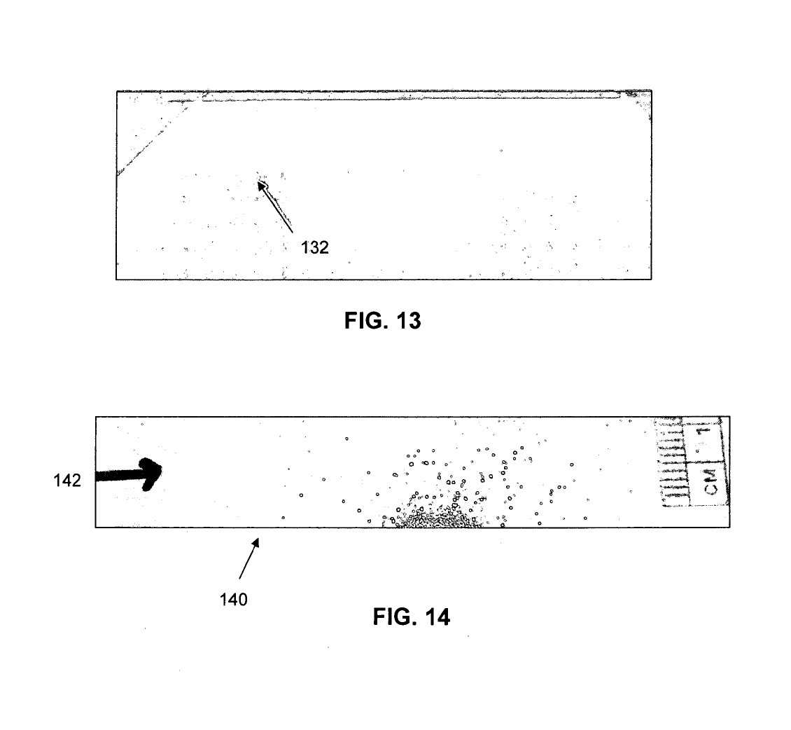

FIG. 13 illustrates a two-layer pigmented coating with thickness of 0.13 mm (5 mils) for each layer, according to an embodiment of the invention, applied to a concrete floor having an area of over 18.58 square meters (200 square feet). The pigmented primer coating composition was cured using a radiation source having a width of 0.66 m (26 inches). The photograph of the cured coating in FIG. 13 demonstrates that the radiation-curable coating is free of wrinkles in spite of the use of multiple passes of the radiation source over the uncured coating composition. Rather, the only visible mark on the cured coating comprises a faint gloss line 132, which will no longer be visible following application of a clear topcoat coating. The pigmented primer coating composition was cured using a HID Hammerhead UV Floor Curing Equipment model 26-8000A, as shown in FIG. 6, having 8000 watts and powered at 208/240 volts, 60 hertz, 45 amps, with an automatic propulsion cure speed of about 7.62 m (25 feet) per minute. The photograph of the cured coating in FIG. 14 also demonstrates that the UV-curable coating is free of wrinkles or buckles in spite of the use of more than one pass of the UV radiation source over the uncured coating composition. The coating composition 140 was applied at a wet thickness of 4 mils, and the second cure pass was performed 10 minutes after the first cure pass. The arrow position 142 indicates where the shoulder area was located following the first pass. Clearly, there are no visible wrinkles located in the shoulder area shown in the close-up photograph of the cured coating composition.

In certain embodiments of the invention, a pigmented radiation-curable coating composition is provided comprising one or more acrylate monomers or oligomers having at least four crosslinkable double bonds, at least one photoinitiator, one or more fillers, and at least one pigment or dye, the coating composition comprising a thickness of at least 4 mils on the surface. In other embodiments, the composition further comprises one or more tertiary amines comprising zero or one crosslinkable double bonds, such as in an amount providing an amine value of at least 7.5 milligrams potassium hydroxide (KOH) per gram of the total radiation-curable resins in the coating composition, to provide synergistically enhanced polymerization of the coating composition.

In an embodiment of the current invention, a method is provided for coating a concrete floor comprising applying a pigmented coating composition over a predetermined area of a surface of a concrete floor, wherein the coating composition comprises one or more acrylate monomers or oligomers having at least four crosslinkable double bonds, at least one photoinitiator, one or more fillers, and at least one pigment or dye, the coating composition comprising a thickness of at least 0.10 mm (4 mils) on the surface. In other embodiments, the composition further comprises one or more tertiary amines, such as in an amount comprising an amine value of at least 7.5 milligrams KOH per gram of the total radiation-curable resins in the coating composition. The method further comprises passing a radiation source over a first portion of the predetermined area of the surface to cure the coating composition, the first portion comprising a main body area, in an initial pass. A shoulder area is directly adjacent to the main body area and does not have the UV radiation source pass over it in the initial pass but has a portion that is partially cured by the stray light leaked from the edge of the light shield. Then, the radiation source is passed over a second portion of the predetermined area of the surface to cure the coating composition, wherein the second portion includes the shoulder area directly adjacent the first portion. The shoulder area in some embodiments has a width of at least half of a centimeter, at least one centimeter, at least five centimeters, or at least ten centimeters. The passing over the second portion occurs between about 0.5 minutes and thirty minutes after the passing over the first portion, such as at least about one minute, or at least about two minutes, or at least about five minutes, or at least about ten minutes, or at least about twenty minutes, or at least about thirty minutes. The shoulder area is not visible following the passing of the radiation source over the second portion, for example the shoulder area directly adjacent the first portion is planar and/or free of wrinkles and/or buckles following the passing of the UV radiation source over the second portion.

The passing of the radiation source according to embodiments of the invention occurs at a rate of between about 4.57 m (15 feet) per minute and about 15.25 m (50 feet) per minute, such as between about 6.10 m (20 feet) per minute and about 12.20 m (40 feet) per minute, for instance about 7.62 m (25 feet) per minute. For a coated surface comprising a length of 30.48 m (100 feet), it would take at least about 8 minutes to complete two full passes of the radiation source at a pass rate of about 7.62 m (25 feet) per minute, back and forth along the length of the surface, in order to cure two directly adjacent portions of the coated surface. Similarly, for a coated surface comprising a length of 60.10 m (200 feet), it would take at least about 10 minutes to complete two full passes of the radiation source at a pass rate of about 12.20 m (40 feet) per minute, back and forth along the length of the surface, in order to cure two directly adjacent portions of the coated surface. Consequently, embodiments of the current invention allow surface areas comprising a length of at least 15.24 m (50 feet) and up to about 137.16 m (450) feet to be coated to a thickness of greater than 0.07 mm (3 mils) and cured at a radiation source pass rate of between about 4.57 m (15 and about 15.24 m (50 feet) per minute, without forming visible wrinkles in the coating.

In an embodiment of the current invention, a coated concrete floor is provided, comprising a surface and a pigmented coating composition applied to the surface. The coating composition comprises one or more acrylate monomers or oligomers having at least four crosslinkable double bonds, at least one photoinitiator, one or more fillers, and at least one pigment or dye, the coating composition comprising a thickness of at least 0.10 mm (4 mils) on the surface. In other embodiments, the composition further comprises one or more tertiary amines, in an amount comprising an amine value of at least 7.5 milligrams potassium hydroxide KOH per gram of the total radiation-curable resins in the coating composition.

In an embodiment of the current invention, a coated concrete floor is provided coated by the method comprising applying a pigmented coating composition over a predetermined area of a surface of a concrete floor, the coating composition comprising one or more acrylate monomers or oligomers having at least four crosslinkable double bonds, at least one photoinitiator, one or more fillers, and at least one pigment or dye, the coating composition comprising a thickness of at least 0.10 mm (4 mils) on the surface. In other embodiments, one or more tertiary amines are further provided, in an amount comprising an amine value of at least 7.5 milligrams KOH per gram of the total radiation-curable resins in the coating composition. The method further comprises passing a radiation source over a first portion of the predetermined area of the surface to cure the coating composition, the first portion comprising a main body area in a first pass. The UV radiation source does not pass over a shoulder area directly adjacent to the main body area during the first pass but has stray light leaked from the edge of the light shield partially curing a portion of the coating at the shoulder area. Then the radiation source is passed over a second portion of the predetermined area of the surface to cure the coating composition, the second portion including the shoulder area directly adjacent the first portion. The shoulder area can have a width, in certain embodiments, of at least half of an inch, or at least one inch, or at least one and a half inches, or at least two inches. The passing over the second portion finishes at least about 0.5 minutes after the passing over the first portion begins, and the shoulder area directly adjacent the first portion is planar and/or free of wrinkles and/or buckles following the passing of the UV radiation source over the second portion.

### EXAMPLES

The following examples, except where noted below, are illustrative of embodiments of the present invention, as described above, and are not meant to limit the invention in any way.

### Example 1

As noted above, Example 1 details a composition according to an embodiment of the invention, in which a combination of 20% by weight of Sartomer SR 399, having an acrylate functionality of five, with Sartomer SR 349 (ethoxylated₃ bis-A diacrylate), filler (110P8 hollow glass spheres by Potters Industries Inc.), pigments (V818 and V823 are pigment dispersions from DSM Desotech), and photoinitiators, successfully provides a 4 mil thick radiation-curable composition that is free of wrinkles upon curing of more than one adjacent section of a coated surface. The pigmented UV radiation-curable coating comprises the materials provided in Table 1 below.

A UV radiation-curable coating is prepared comprising the materials listed in Table 1, then applied to a 10.16 cm×15.24 cm (4 inch×6 inch) metal substrate, to a thickness of 0.10 mm (4 mils). Next, one portion of the coating is cured using a HID Hammerhead UV Floor Curing Equipment model 26-8000A (as shown in FIG. 6) as the radiation source. The HID Hammerhead machine comprises a mercury vapor lamp, provides 8000 watts and is powered at 208/240 volts, 60 hertz, 45 amps, with an automatic propulsion cure speed of about 7.62 m (25 feet) per minute. Following curing of the first pass, observation of the cured pigmented primer coating at the shoulder area starts to shows wrinkles at about 1.5 minutes.

TABLE 1

| Product | Chemical Type | Amount (wt %) |
|---|---|---|
| SR 349 | ethoxylated bisphenol A diacrylate | 54.5% |
| | monomer | |
| SR 399 | dipentaerythritol pentaacrylate monomer | 20% |
| 110P8 | hollow glass spheres | 20% |
| Irgacure 184 | 1-hydroxycyclohexyl benzophenone | 1% |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| | Total: | 100% |
| | Wrinkle delay for a 4 mil coating: | 1.5 minutes |

### Example 2

A composition comprising a combination of 20% by weight of Sartomer SR 399, having an acrylate functionality of five, with Sartomer SR 349 (ethoxylated₃ bis-A diacrylate), Sartomer CN 383, a filler of hollow glass spheres Sphericel 110P8 (Potters Industries Inc.), pigments, and photoinitiators, successfully provides a 4 mil thick pigmented radiation-curable composition that is free of wrinkles upon curing of more than one overlapping section of a coated surface. The UV radiation-curable coating comprises the materials provided in Table 2 below. A UV radiation-curable coating is prepared comprising the materials listed in Table 2, then applied as a primer coating to a 10.16 cm×15.24 cm (4 inch×6 inch) metal substrate to a thickness of 0.10 mm (4 mils). Next, the 4 mil thick coating is cured according to the method described in Example 1. Following curing of the first pass observation of the cured pigmented primer coating shows no visible wrinkles after at least about 10 minutes.

TABLE 2

| Product | Chemical Type | Amount (wt %) |
|---|---|---|
| SR 349 | ethoxylated (3) bisphenol A diacrylate | 44.5% |
| | monomer | |
| SR 399 | dipentaerythritol pentaacrylate monomer | 20% |
| Irgacure 184 | 1-hydroxycyclohexyl benzophenone | 1% |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| 110P8 | hollow glass spheres | 20% |
| | Total: | 100% |
| | Wrinkle delay for a 4 mil coating: | >10 minutes |

### Example 3

A composition comprising a combination of 30% by weight of Sartomer SR 355, having an acrylate functionality of four, with Sartomer SR 349 (ethoxylated₃ bis-A diacrylate), Sartomer CN 383, filler (110P8 hollow glass spheres), pigments, and photoinitiators, successfully provides a 4 mil thick pigmented radiation-curable composition that is free of wrinkles upon curing of more than one adjacent section of a coated surface. The UV radiation-curable coating comprises the materials provided in Table 3 below. A UV radiation-curable coating is prepared comprising the materials listed in Table 3, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating starts to show visible wrinkles at about 50 seconds.

TABLE 3

| Product | Chemical Type | Amount (wt %) |
|---|---|---|
| SR 349 | ethoxylated (3) bisphenol A diacrylate | 35.5% |
| | monomer | |
| SR 355 | di-trimethylolpropane tetraacrylate | 30% |
| | monomer | |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| 110P8 | hollow glass spheres filler | 20% |
| | Total: | 100% |
| | Wrinkle delay for a 4 mil coating: | 50 seconds |

### Example 4

A composition comprising a combination of 20% by weight of Sartomer SR 399, having an acrylate functionality of five, with Sartomer SR 349 (ethoxylated₃ bis-A diacrylate), Sartomer CN 383, filler (110P8 hollow glass spheres), Sartomer SR 495 (caprolactone acrylate), pigments, and photoinitiators, successfully provides a 4 mil thick pigmented radiation-curable composition that is free of wrinkles upon curing of more than one adjacent section of a coated surface. The UV radiation-curable coating comprises the materials provided in Table 4 below. A UV radiation-curable coating is prepared comprising the materials listed in Table 4, then applied as a primer coating to a 10.16 cm×15.24 cm (4 inch×6 inch) metal substrate to a thickness of 0.10 mm (4 mils). Next, the 4 mil thick coating is cured according to the method described in Example 1. Following curing of the first pass, observation of the cured pigmented primer coating starts to show visible wrinkles at about eight minutes.

TABLE 4

| Product | Chemical Type | Amount (wt %) |
|---|---|---|
| SR 349 | ethoxylated (3) bisphenol A diacrylate | 35.5% |
| | monomer | |
| SR 399 | dipentaerythritol pentaacrylate monomer | 20% |
| SR 495 | caprolactone acrylate monomer | 10% |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| 110P8 | hollow glass spheres filler | 20% |
| | Total: | 100% |
| | Wrinkle delay for a 4 mil coating: | 8 minutes |

### Example 5

A composition comprising a combination of 20% by weight of Sartomer SR 399, having an acrylate functionality of five, with Sartomer SR 349 (ethoxylated₃ bis-A diacrylate), Sartomer CN 383, filler (110P8 hollow glass spheres), Sartomer CN 104 (epoxy acrylate), pigments, and photoinitiators, successfully provides a 4 mil thick pigmented radiation-curable composition that is free of wrinkles upon curing of more than one adjacent section of a coated surface. The UV radiation-curable coating comprises the materials provided in Table 5 below. A UV radiation-curable coating is prepared comprising the materials listed in Table 5, then applied as a primer coating to a 10.16 cm×15.24 cm (4 inch×6 inch) metal substrate to a thickness of 0.10 mm (4 mils). Next, the 0.10 mm (4 mil) and 0.20 mm (8 mil) thick coatings are cured according to the method described in Example 1. Following curing of the first pass, observation of the cured pigmented primer coating shows no visible wrinkles after at least about ten minutes.

TABLE 5

| Product | Chemical Type | Amount (wt %) |
|---|---|---|
| SR 349 | ethoxylated (3) bisphenol A diacrylate | 35.5% |
| | monomer | |
| SR 399 | dipentaerythritol pentaacrylate monomer | 20% |
| CN 104 | epoxy acrylate oligomer | 10% |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| 110P8 | hollow glass spheres filler | 20% |
| | Total: | 100% |
| | Wrinkle delay for a 4 mil coating: | >10 minutes |

### Example 6

A composition comprising a combination of 20% by weight of Sartomer SR 399, having an acrylate functionality of five, with Sartomer SR 349 (ethoxylated₃ bis-A diacrylate), Sartomer CN 383, tiller (110P8 hollow glass spheres), Cytec EB 891 (modified polyester acrylate oligomer), pigments, and photoinitiators, successfully provides a 4 mil thick pigmented radiation-curable composition that is free of wrinkles upon curing of more than one adjacent section of a coated surface. The UV radiation-curable coating comprises the materials provided in Table 6 below. A UV radiation-curable coating is prepared comprising the materials listed in Table 6, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating starts to show visible wrinkles at about two minutes.

TABLE 6

| Product | Chemical Type | Amount (wt %) |
|---|---|---|
| SR 349 | ethoxylated (3) bisphenol A diacrylate | 35.5% |
| | monomer | |
| SR 399 | dipentaerythritol pentaacrylate monomer | 20% |
| EB 891 | modified polyester acrylate oligomer | 10% |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| 110P8 | hollow glass spheres filler | 20% |
| | Total: | 100% |
| | Wrinkle delay for a 4 mil coating: | 2 minutes |

### Example 7

A composition comprising a combination of 20% by weight of Sartomer SR 399, having an acrylate functionality of five, with Sartomer SR 349 (ethoxylated₃ bis-A diacrylate), Sartomer SR 502 (ethoxylated₃ trimethylolpropane triacrylate), Sartomer CN 383, filler (110P8 hollow glass spheres), pigments, and photoinitiators, successfully provides a 4 mil thick pigmented UV-curable composition that is free of wrinkles upon curing of more than one adjacent section of a coated surface. The UV-curable coating comprises the materials provided in Table 7 below. A UV-curable coating is prepared comprising the materials listed in Table 7, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating shows no visible wrinkles for at least about ten minutes.

TABLE 7

| Product | Chemical Type | Amount (wt %) |
|---|---|---|
| SR 349 | ethoxylated (3) bisphenol A diacrylate | 35.5% |
| | monomer | |
| SR 399 | dipentaerythritol pentaacrylate monomer | 20% |
| SR 502 | ethoxylated (9) trimethylolpropane | 10% |
| | triacrylate monomer | |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| 110P8 | hollow glass spheres filler | 20% |
| | Total: | 100% |
| | Wrinkle delay for a 4 mil coating: | >10 minutes |

### Example 8

A composition comprising a combination of 20% by weight of Sartomer SR 399, having an acrylate functionality of five, with Sartomer SR 349 (ethoxylated₃ bis-A diacrylate), Sartomer CN 975 (urethane acrylate (60-70% PETA)), Sartomer CN 383, filler (110P8 hollow glass spheres), pigments, and photoinitiators, successfully provides a 4 mil thick pigmented UV-curable composition that is free of wrinkles upon curing of more than one adjacent section of a coated surface. The UV-curable coating comprises the materials provided in Table 10 below. A UV-curable coating is prepared comprising the materials listed in Table 10, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating shows no visible wrinkles for at least about 10 minutes.

TABLE 8

| Product | Chemical Type | Amount (wt %) |
|---|---|---|
| SR 349 | ethoxylated (3) bisphenol A diacrylate | 35.5% |
| | monomer | |
| SR 399 | dipentaerythritol pentaacrylate monomer | 20% |
| CN 975 | urethane acrylate oligomer (60-70% | 10% |
| | PETA) | |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| 110P8 | hollow glass spheres filler | 20% |
| | Total: | 100% |
| | Wrinkle delay for a 4 mil coating: | >10 minutes |

### Example 9

A composition comprising a combination of 20% by weight of Sartomer SR 399, having an acrylate functionality of five, with Sartomer SR 349 (ethoxylated₃ bis-A diacrylate), Sartomer CN 383, 10% filler (110P8 hollow glass spheres), pigments, and photoinitiators, successfully provides a 4 mil thick pigmented UV-curable composition that is free of wrinkles upon curing of more than one adjacent section of a coated surface. The UV-curable coating comprises the materials provided in Table 9 below. A UV-curable coating is prepared comprising the materials listed in Table 9, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating starts to show visible wrinkles at about 1.5 minutes.

TABLE 9

| Product | Chemical Type | Amount (wt %) |
|---|---|---|
| SR 349 | ethoxylated (3) bisphenol A diacrylate | 54.5% |
| | monomer | |
| SR 399 | dipentaerythritol pentaacrylate monomer | 20% |
| Irgacure 184 | 1-hydroxycyclohexyl benzophenone | 1% |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| 110P8 | hollow glass spheres filler | 10% |
| | Total: | 100% |
| | Wrinkle delay for a 4 mil coating: | 1.5 minutes |

### Example 10

A composition comprising a combination of 20% by weight of Sartomer SR 399, having an acrylate functionality of five, with Sartomer SR 349 (ethoxylated₃ bis-A diacrylate), Sartomer CN 383, filler (aluminum trihydrate), pigments, and photoinitiators, successfully provides a 4 mil thick pigmented UV-curable composition that is free of wrinkles upon curing of more than one adjacent section of a coated surface. The UV-curable coating comprises the materials provided in Table 10 below. A UV-curable coating is prepared comprising the materials listed in Table 10, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating starts to show visible wrinkles at about 3 minutes.

TABLE 10

| Product | Chemical Type | Amount (wt %) |
|---|---|---|
| SR 349 | ethoxylated (3) bisphenol A diacrylate | 44.5% |
| | monomer | |
| SR 399 | dipentaerythritol pentaacrylate monomer | 20% |
| Irgacure 184 | 1-hydroxycyclohexyl benzophenone | 1% |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| ATH | aluminum trihydrate | 20% |
| | Total: | 100% |
| | Wrinkle delay for a 4 mil coating: | 3 minutes |

### Example 11

A composition comprising a combination of 20% by weight of Sartomer SR 399, having an acrylate functionality of five, with Sartomer SR 349 (ethoxylated₃ bis-A diacrylate), Sartomer CN 383, filler (barium sulfate), pigments, and photoinitiators, successfully provides a 4 mil thick pigmented UV-curable composition that is free of wrinkles upon curing of more than one adjacent section of a coated surface. The UV-curable coating comprises the materials provided in Table 11 below. A UV-curable coating is prepared comprising the materials listed in Table 11, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating starts to show wrinkles at about 6 minutes.

TABLE 11

| Product | Chemical Type | Amount (wt %) |
|---|---|---|
| SR 349 | ethoxylated (3) bisphenol A diacrylate | 44.5% |
| | monomer | |
| SR 399 | dipentaerythritol pentaacrylate monomer | 20% |
| Irgacure 184 | 1-hydroxycyclohexyl benzophenone | 1% |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium | 2.33% |
| | dioxide | |
| CN 383 | tertiary amine compound with zero | 10% |
| | crosslinkable double bonds | |
| barium sulfate | barium sulfate | 20% |
| | Total: | 100% |
| | Wrinkle delay for a 4 mil coating: | 6 minutes |

### Example 12

A composition comprising a combination of 20% by weight of Sartomer SR 399, having an acrylate functionality of five, with Sartomer SR 349 (ethoxylated₃ bis-A diacrylate), Sartomer CN 383, filler (731EC—milled glass fiber from Owens Corning), pigments, and photoinitiators, successfully provides a 4 mil thick pigmented UV-curable composition that is free of wrinkles upon curing of more than one adjacent section of a coated surface. The UV-curable coating comprises the materials provided in Table 12 below. A UV-curable coating is prepared comprising the materials listed in Table 12, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating starts to show visible wrinkles at about 5 minutes.

TABLE 12

| Product | Chemical Type | Amount (wt %) |
|---|---|---|
| SR 349 | ethoxylated (3) bisphenol A diacrylate | 44.5% |
| | monomer | |
| SR 399 | dipentaerythritol pentaacrylate monomer | 20% |
| Irgacure 184 | 1-hydroxycyclohexyl benzophenone | 1% |
| Irgacure 819 | bis(2,4,6-trimethylbenzoyl)- | 2% |
| | phenylphosphineoxide | |
| V818 | dispersion of 20% carbon black | 0.17% |
| V823 | dispersion of 60% rutile titanium dioxide | 2.33% |
| CN 383 | tertiary amine compound with zero | 10% |
| | crosslinkable double bonds | |
| 731EC | milled glass fiber | 20% |
| | Total: | 100% |
| | Wrinkle delay for a 4 mil coating: | 5 minutes |

### Example 13

A composition comprising a combination of 18.8% by weight of Sartomer SR 399, having an acrylate functionality of five, with Sartomer SR 349 (ethoxylated₃ bis-A diacrylate), Sartomer CN133, Sartomer CN 383, Sartomer CN131B, BASF Palamoll 656, filler (Sphericel 110P8—hollow glass spheres from Potter Industries), pigments, photoinitiators, wetting agent, rheology modifier and defoamer successfully provides a 4 mil thick pigmented UV-curable composition that is free of wrinkles upon curing of more than one adjacent section of a coated surface. The UV-curable coating comprises the materials provided in Table 13 below. A UV-curable coating is prepared comprising the materials listed in Table 13, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating shows no visible wrinkles after at least 10 minutes.

TABLE 13

| Product | Chemical Type | Amount (wt %) |
|---|---|---|
| SR 349 | ethoxylated (3) bisphenol A diacrylate | 10.1% |
| | monomer | |
| SR 399 | dipentaerythritol pentaacrylate monomer | 18.8% |
| CN 133 | aliphatic triacrylate oligomer | 5.8% |
| Irgacure 819 | bis(2,4,6-trimethylbenzoyl)- | 1.8% |
| | phenylphosphineoxide | |
| V818 | dispersion of 20% carbon black | 0.16% |
| V823 | dispersion of 60% rutile titanium dioxide | 1.34% |
| CN 383 | tertiary amine compound with zero | 7.2% |
| | crosslinkable double bonds | |
| CN131B | aromatic monoacrylate oligomer | 19.5% |
| Palamoll 656 | adipic acid ester polymer | 8.7% |
| Sphericel | hollow glass spheres | 25.0% |
| 110P8 | | |
| wetting | | 0.35% |
| agent | | |
| rheology | | 0.75% |
| modifier | | |
| Defoamer | | 0.50% |
| | Total: | 100% |
| | Wrinkle delay for a 4 mil coating: | >10 minutes |

### Comparative Example 14

### Not an Example of the Instant Claimed Invention

A composition comprising a combination of 5% by weight of Sartomer SR 399, having an acrylate functionality of five, with NeoRad U-10 (aliphatic urethane acrylate oligomer), Sartomer 454 (ethoxylated trimethylolpropane triacrylate), Sartomer SR 306 (tripropylene glycol diacrylate), Sartomer SR 349 (ethoxylated bisphenol A diacrylate), pigments, and photoinitiators, does not successfully provide a 4 mil thick pigmented radiation-curable composition that is free of wrinkles upon curing of more than one overlapping section of a coated surface. The radiation-curable coating comprises the materials provided in Table 14 below. A radiation-curable coating is prepared comprising the materials listed in Table 14, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coatings essentially instantly, for instance within less than about five seconds, shows visible wrinkles, thus this radiation-curable composition formulation is not capable of providing a cured coating free of wrinkles at a thickness of 0.10 mm (4 mils).

TABLE 14
Comparative Example - Not an example of the instant
claimed invention

| Product | Chemical Type | Amount (wt %) |
|---|---|---|
| Neorad U-10 | aliphatic urethane acrylate oligomer | 30% |
| SR 399 | dipentaerythritol pentaacrylate monomer | 5% |
| SR 306 | tripropylene glycol diacrylate monomer | 18% |
| SR 454 | ethoxylated (3) trimethyl propane | 19% |
| | triacrylate monomer | |
| SR 349 | ethoxylated (3) bisphenol A diacrylate | 20% |
| | monomer | |
| Darocure | 2-hydroxy-2-methyl propiophenone | 1% |
| 1173 | | |
| Irgacure 184 | 1-hydroxycyclohexyl benzophenone | 1% |
| Irgacure 819 | bis(2,4,6-trimethylbenzoyl)- | 3.5% |
| | phenylphosphineoxide | |
| V818 | dispersion of 20% carbon black | 0.17% |
| V823 | dispersion of 60% rutile titanium dioxide | 2.33% |
| | Total: | 100% |
| | Wrinkle delay for a 4 mil coating: | less than 5 |
| | | seconds |

As discussed above, one method for standardizing the wrinkle formation of a composition is to test the wrinkle formation of the base composition containing 0.5% by weight titanium dioxide as the only pigment. Accordingly, the formulation of Comparative Example 14 is prepared in which the V818 black pigment is left out and only 0.84% of the V823 dispersion of 60% rutile titanium dioxide pigment is included. The composition comprising a combination of 5.1% by weight of Sartomer SR 399, having an acrylate functionality of five, with NeoRad U-10 (aliphatic urethane acrylate oligomer), Sartomer 454 (ethoxylated₃ trimethylolpropane triacrylate), Sartomer SR 306 (tripropylene glycol diacrylate), Sartomer SR 349 (ethoxylated₃ bisphenol A diacrylate), pigments, and photoinitiators, does not successfully provide a 4 mil thick pigmented UV-curable composition that is free of wrinkles upon curing of more than one overlapping section of a coated surface.

The UV-curable coating comprises the materials provided in Table 15 below. A UV-curable coating is prepared comprising the materials listed in Table 15, then applied as a primer coating to a 10.16 cm×15.24 cm (4 inch×6 inch) metal substrate to a thickness of 0.10 mm (4 mils). Next, the 0.10 mm (4 mil) thick coating is cured according to the method described in Example 1. Following curing of the first pass, observation of the cured pigmented primer coating essentially instantly, for instance within about five seconds, shows visible wrinkles, thus this standardized UV-curable composition formulation is not capable of providing a cured coating free of wrinkles at a thickness of 0.10 mm (4 mils).

TABLE 15
Comparative Example - Not an example of the instant
claimed invention

| Product | Chemical Type | Amount (wt %) |
|---|---|---|
| Neorad U-10 | aliphatic urethane acrylate oligomer | 30.5% |
| SR 399 | dipentaerythritol pentaacrylate monomer | 5.1% |
| SR 306 | tripropylene glycol diacrylate monomer | 18.3% |
| SR 454 | ethoxylated (3) trimethyl propane | 19.3% |
| | triacrylate monomer | |
| SR 349 | ethoxylated (3) bisphenol A diacrylate | 20.3% |
| | monomer | |
| Darocure | 2-hydroxy-2-methyl propiophenone | 1.03% |
| 1173 | | |
| Irgacure 184 | 1-hydroxycyclohexyl benzophenone | 1.03% |
| Igracure 819 | bis(2,4,6-trimethylbenzoyl)- | 3.6% |
| | phenylphosphineoxide | |
| V823 | dispersion of 60% rutile titanium dioxide | 0.84% |
| | Total: | 100% |
| | Wrinkle delay for a 4 mil coating: | less than |
| | | 5 seconds |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. The claims are to be construed to include alternative embodiments to the extent permitted by the prior art.

1. A radiation-curable coating composition for a concrete floor comprising:
one or more acrylate monomers or oligomers having at least four crosslinkable double bonds;
at least one photoinitiator;
between about 10% and about 50% by weight relative to the total weight of the coating composition of at least one filler; and
at least 0.5% by weight relative to the total weight of the coating composition of at least one pigment or dye;
wherein when the composition is applied over a predetermined area of a surface of a concrete floor at a thickness of at least 0.10 mm on the surface, and a radiation source is passed over a first portion of the predetermined area of the surface to cure the coating composition, a shoulder area of the predetermined area that includes partially cured coating, that is directly adjacent the first portion and that has not had the UV radiation source pass directly over it, has no wrinkles at least 0.5 minute, preferably at least 1 minute, more preferably at least 2 minutes, following the completion of the passing of the UV radiation source over the first portion.

2. The coating composition of claim 1, wherein the coating composition comprises at least 5% by weight relative to the total weight of the coating composition, preferably at least 10% by weight, of the one or more acrylate monomers or oligomers having four or more crosslinkable double bonds,
preferably the one or more acrylate monomers or oligomers having four or more crosslinkable double bonds are selected from the group consisting of di-trimethylolpropanetetraacrylate monomer, dipentaerythritolpentaacrylate, and combinations thereof.

3. The coating composition of claim 1, further comprising at least one tertiary amine compound comprising zero or one crosslinkable double bonds, wherein the at least one tertiary amine compound preferably has an amine value of at least 7.5 mg KOH per gram of total radiation-curable resins of the coating composition, the at least one tertiary amine preferably being selected from the group consisting of triethylamine, triethanolamine, N,N-dimethyl-p-toluidine, methyldiethanolamine, dimethylethanolamine, 2-n-butoxyethyl-4-dimethylaminobenzoate, 2-ethyl-p-(N,N-dimethylamino)benzoate, and 2-ethylhexyl-p-dimethylaminobenzoate.

4. The coating composition according to claim 1, wherein the radiation source provides radiation wavelengths between about 100 nm and about 700 nm and/or wherein the radiation is emitted by source selected from the group consisting of at least one lamp, at least one bulb, at least one LED, and combinations thereof.

5. The coating composition according to claim 1, wherein the at least one photoinitiator comprises a Norrish Type I photoinitiator, preferably selected from the group consisting of acyl phosphine oxides, benzoin ethers, 2,2-diethoxyacetophenone, benzyl dimethylketal, 1-hydroxycyclohexylphenyl-ketone, 1-hydroxycyclohexyl benzophenone, 2-hydroxy-2-methyl propiophenone, 2-ethoxy-2-isobutoxyacetophenone, 2,2-dimethyl-2-hydroxyacetophenone, 2,2-dimethoxy-2-phenylacetophenone, 2,2,2-trichloro-4-t-butylacetophenone, 2,2-dimethyl-2-hydroxy-4-t-butylacetophenone, 1-phenyl-1,2-propanedione-2-O-ethoxycarbonyl ester, 1-phenyl-1,2-propanedione-2-O-benzoyl oxime, and combinations thereof.

6. The coating composition of claim 1, wherein the at least one filler is selected from the group consisting of silica oxide particles, silicate particles, ceramic spheres, clay particles, calcium carbonate particles, aluminum oxide particles, aluminum hydroxide particles, aluminium trihydrate particles, calcium sulfate particles, barium sulfate particles, solid glass beads, hollow glass beads, glass fibers, glass flakes, acrylic particles, polyolefin particles, silicon particles, and combinations thereof.

7. The coating composition according to claim 1, wherein the coating composition is applied to a surface at a thickness of at least 0.13 mm, at least 0.15 mm, at least 0.18 mm, at least 0.20 mm, at least 0.23 mm, or at least 0.25 mm.

8. The coating composition according to claim 1, wherein the pigment is present in an amount such that when the coating composition comprises one or more acrylate monomers or oligomers having fewer than four crosslinkable double bonds in place of the one or more acrylate monomers or oligomers having four or more crosslinkable double bonds, the cured coating comprises a visible wrinkle.

9. The coating composition according to claim 1, wherein the coating composition passes the 0.5% titanium dioxide test, the 0.5% titanium dioxide test being that when the coating composition comprises 0.5% by weight relative to the total weight of the coating composition of titanium dioxide pigment as the only pigment in the composition, when the coating composition is applied to a surface at a thickness of 0.10 mm, and when the coating composition on the surface is subjected to a plurality of curing passes of a UV radiation source and the time lapse between the start of any one of the plurality of curing passes and the finish of the next directly adjacent curing pass is about 0.5 minutes, the cured composition is planar and has no wrinkles.

10. A method for coating a concrete floor comprising:
applying a coating composition, preferably according to claim 1, in a predetermined area over a surface of a concrete floor, the coating composition comprising one or more acrylate monomers or oligomers having at least four crosslinkable double bonds, at least one photoinitiator, between about 10% and about 50% by weight relative to the total weight of the coating composition of at least one filler, and at least 0.5% by weight relative to the total weight of the coating composition of at least one pigment or dye, the coating composition comprising a thickness of at least 0.10 mm on the surface; and
passing a radiation source over a first portion of the predetermined area of the surface to cure the coating composition,
wherein a shoulder area of the predetermined area that includes partially cured coating, that is directly adjacent the first portion and that has not had the UV radiation source pass directly over it, has no wrinkles at least 0.5 minute, preferably at least 1 minute, more preferably at least 2 minutes, following the completion of the passing of the UV radiation source over the first portion.

11. The method of claim 10, wherein the radiation source provides radiation wavelengths between about 100 nm and about 700 nm and/or wherein the radiation is emitted by a source selected from the group consisting of at least one lamp, at least one bulb, at least one LED, and combinations thereof.

12. The method according to claim 10, wherein the radiation source is passed over the predetermined area of the concrete surface at a speed of between about 6.10 m per minute and about 18.3 m per minute and/or wherein the shoulder area has a width of at least 0.5 centimeters.

13. A coated concrete floor comprising:
a floor comprising a surface; and
a coating composition applied directly to the surface, the coating composition comprising one or more acrylate monomers or oligomers having at least four crosslinkable double bonds, at least one photoinitiator, between about 10% and about 50% by weight relative to the total weight of the coating composition of at least one filler, and at least 0.5% by weight relative to the total weight of the coating composition of at least one pigment or dye, said coating composition preferably being a coating composition according to claim 1,
wherein the coating composition has a thickness of at least 0.10 mm.

14. The coated concrete floor of claim 13, wherein when the coating composition on the surface is subjected to a plurality of curing passes of a UV radiation source and the time lapse between the start of any one of the plurality of curing passes and the finish of the next directly adjacent curing pass is at least about 0.5 minute, preferably at least 1 minute, more preferably at least 2 minutes, the cured composition is planar and has no wrinkles.

15. The coated concrete floor of claim 13, wherein the coating composition passes the titanium dioxide test, the 0.5% titanium dioxide test being that when the coating composition comprises 0.5% by weight relative to the total weight of the coating composition of titanium dioxide pigment as the only pigment in the composition, when the coating composition is applied to a surface at a thickness of 0.10 mm, and when the coating composition on the surface is subjected to a plurality of curing passes of a UV radiation source and the time lapse between the start of any one of the plurality of curing passes and the finish of the next directly adjacent curing pass is about 0.5 minutes, the cured composition is planar and has no wrinkles.
